(19) United States
(12) Patent Application Publication
(10) Pub. No.: US 2024/0400763 A1
(43) Pub. Date: Dec. 5, 2024

(54) Technique for Forming a Polyarylene Sulfide Resin

(71) Applicant: Ticona LLC, Florence, KY (US)

(72) Inventor: Hendrich Chiong, Cincinnati, OH (US)

(21) Appl. No.: 18/661,767

(22) Filed: May 13, 2024

Related U.S. Application Data
(60) Provisional application No. 63/505,074, filed on May 31, 2023.

(51) Int. Cl. C08G 75/029; C08G 75/0209; C08G 75/0254; C08G 75/0259; C08K 9/06

(52) U.S. Cl. CPC C08G 75/029; C08G 75/0209; C08G 75/0254; C08G 75/0259; C08K 9/06

(57) ABSTRACT

A method for forming a polyarylene sulfide resin is provided. The method comprises reacting an arylene sulfide polymer containing halogen end groups with an end group-modifying compound to form the polyarylene sulfide resin, wherein the end group-modifying compound includes an organic salt of an aminoalkyl carboxylic acid.

### RELATED APPLICATION

The present application is based upon and claims priority to U.S. Provisional Patent Application Ser. No. 63/505,074, having a filing date of May 31, 2023, which is incorporated herein by reference.

### BACKGROUND OF THE INVENTION

Polyarylene sulfides, such as polyphenylene sulfide (“PPS”) are engineering plastic materials that are excellent in heat resistance, chemical resistance, flame retardancy, mechanical strength, electrical properties, and dimensional stability. Because PPS can be molded into various molded articles, films, sheets, and fibers by general melt processing methods, it is widely used in fields such as electronic and electrical equipment, automobile equipment, and so on. In most commercial applications, PPS is blended and modified with reinforcing fibers (e.g., glass fibers) and other types of fillers (e.g., impact modifiers, mineral particles, etc.). To help increase the adhesion with PPS, the reinforcing fibers are often treated with a sizing composition that contains an organosilane compound. Organosilane coupling agents may also be employed in the composition itself to help improve adhesion of PPS with the reinforcing fibers. Unfortunately, one of the limitations in improving adhesion is that PPS typically has a relatively low concentration of polar end groups that exhibit a high degree of reactivity with silane compounds, which ultimately minimizes their overall effectiveness. As such, a need currently exists for a technique of improving the reactivity of polyarylene sulfide resins with silane compounds.

### SUMMARY OF THE INVENTION

In accordance with one embodiment of the present invention, a method for forming a polyarylene sulfide resin is disclosed. The method comprises reacting an arylene sulfide polymer containing halogen end groups with an end group-modifying compound to form the polyarylene sulfide resin. The end group-modifying compound includes an organic salt of an aminoalkyl carboxylic acid.

### BRIEF DESCRIPTION OF THE FIGURES

The present invention may be better understood with reference to the following figures:

FIG. 1 illustrates an electric vehicle including components that may incorporate a polymer composition as disclosed herein;

FIG. 2 illustrates one embodiment of a busbar as may incorporate a polymer composition as disclosed herein;

FIG. 3 illustrates a battery assembly that may employ components that may incorporate a polymer composition as disclosed herein;

FIG. 4 illustrates an electronic system as may include components that may incorporate a polymer composition as disclosed herein;

FIG. 5 illustrates a current sensor as may be included in an electronic system as in FIG. 4;

FIG. 6 illustrates an inverter system as may be present in an electric car including components that may incorporate a polymer composition as disclosed herein;

FIG. 7 is a perspective view of one embodiment of a connector that may incorporate a polymer composition as disclosed herein;

FIG. 8 is a plan view of the connector of FIG. 7 in which the first and second connector portions are disengaged;

FIG. 9 is a plan view of the connector of FIG. 7 in which the first and second connector portions are engaged;

FIG. 10 illustrates examples of components that may incorporate a polymer composition as disclosed herein;

FIG. 11 illustrates additional components that may incorporate a polymer composition as disclosed herein;

FIG. 12 illustrates a low temperature thermal loop as may include components that may incorporate a polymer composition as disclosed herein;

FIG. 13 illustrates a high temperature thermal loop as may include components that may incorporate a polymer composition as disclosed herein; and

FIG. 14 illustrates one embodiment of a coolant pump as may incorporate a polymer composition as disclosed herein.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a method for forming a polyarylene sulfide resin that is capable of having an improved affinity to silanes and/or other components of a polymer composition. More particularly, the method includes reacting an arylene sulfide polymer with an end group-modifying compound to reduce the level of halogen end groups (e.g., chlorine end groups), thereby increasing the degree of reactivity of the resulting resin with a silane. Initially, for example, the polymer may contain a relatively high halogen content to help achieve the desired level of silane reactivity. For example, the halogen content may be from about 500 to about 8,000 ppm, in some embodiments from about 1,000 to about 6,500 ppm, and in some embodiments, from about 2,500 to about 5,000 ppm. After treatment, the halogen content may be reduced to a value that is at least about 50% lower, in some embodiments about 70% lower, and in some embodiments, 90% lower than the initial halogen content. For example, the halogen content after treatment may be about 2,500 ppm or less, in some embodiments from about 10 to about 1,500 ppm, and in some embodiments, from about 50 to about 500 ppm.

The end-group modifying compound generally includes a salt of an aminoalkyl carboxylic acid. Particularly suitable aminoalkyl carboxylic acids may include, for example, aminomonoalkyl carboxylic acids, such as 4-(methylamino)butytric acid (NHCH₃(CH₂)₃C(O)OH), 4-(ethylamino)butytric acid (NHCH₂CH₃(CH₂)₃C(O)OH), 4-(methylamino)propionic acid (NHCH₃(CH₂)₂C(O)OH), 4-(ethylamino)propionic acid (NHCH₂CH₃(CH₂)₂C(O)OH), etc.; aminodialkyl carboxylic acids, such as 4-(dimethylamino)butyric acid (NCH₃CH₃(CH₂)₃C(O)OH), etc. Aminomonoalkyl carboxylic acids, such as 4-(methylamino)butytric acid, are particularly suitable. The salt may also include a cation, such as an alkali metal (e.g., lithium, sodium, rubidium, cesium or potassium), alkali earth metal (e.g., calcium, magnesium, etc.), and so forth. Alkali metals, such as sodium, are particularly suitable. In one particular embodiment, for example, the end-group modifying compound may be sodium N-methyl-4-aminobutyrate (“SMAB”).

The aminoalkyl carboxylic acid may be formed using a variety of techniques as are known in the art, such as by reacting an N-alkylated cyclic amide (e.g., lactam, urea, etc.) with a metal hydroxide in the presence of water. Suitable N-alkylated cyclic amides may include, for instance, N-methyl-2-pyrrolidone (“NMP”), N-ethyl-2-pyrrolidone, N-methylcaprolactam, N-methyl-2-piperidone, 1,3-dimethyl-2-imidazolidinone, etc. NMP is particularly suitable. The metal hydroxide may include an alkali metal (e.g., lithium, sodium, rubidium, cesium or potassium), alkali earth metal (e.g., calcium, magnesium, etc.), and so forth. Alkali metal hydroxides, such as sodium hydroxide, are particularly suitable. In one particular embodiment, for example, NMP is reacted with NaOH in the presence of water.

The aminoalkyl carboxylic acid may be pre-formed, such as in a manner described above, and then subsequently reacted with the arylene sulfide polymer. The reaction with the arylene sulfide polymer typically occurs at a high reaction temperature, such as within the range of about 200° C. to about 300° C., in some embodiments from about 220° C. to about 280° C., and in some embodiments, from about 250° C. to about 270° C., and for a period of time of from about 5 minutes to about 500 minutes, in some embodiments from about 30 minutes to about 300 minutes, and in some embodiments, from about 40 minutes to about 200 minutes.

Besides being pre-formed, the aminoalkyl carboxylic acid may also be formed in situ as one or more of the reactants are placed into contact with the arylene sulfide polymer. In fact, one particularly beneficial aspect of the present invention is that the aminoalkyl carboxylic acid can be formed in situ during the process of forming the arylene sulfide polymer resin. Namely, an N-alkylated cyclic amide (e.g., NMP) and/or water are often employed as solvents and/or phase separation agents in the process used to form polyarylene sulfide resin. Thus, by selectively adding the metal hydroxide to the reaction mixture and heating to the desired reaction temperature, the aminoalkyl carboxylic acid can be formed in situ during the reaction process and react with the arylene sulfide polymer to modify the end groups in the manner desired. In one embodiment, for example, the arylene sulfide polymer may be formed by a process that includes initially reacting a sulfur source with a dihaloaromatic compound during a first step to form an arylene sulfide prepolymer and then reacting the arylene sulfide prepolymer with a dihaloaromatic compound during a second step to form an arylene sulfide polymer. The reaction in the first and/or second steps typically occurs in the presence of an N-alkylated cyclic amide (e.g., NMP) and water may be added before, during, and/or after the first and second steps. In this manner, a metal hydroxide (e.g., NaOH) may be added during and/or after the first and/or second steps of the reaction to create a reaction mixture that is capable of further reaction with the arylene sulfide polymer to modify its end groups. Of course, in other embodiments, the metal hydroxide, N-alkylated cyclic amide, and water may be pre-blended, contacted with the arylene sulfide polymer, and then heated to initiate formation of the end group-modifying compound and reaction of such compound with the arylene sulfide polymer.

Regardless of the particular manner in which the reactants are combined with each other and the arylene sulfide polymer, the molar ratio of the N-alkylated cyclic amide, metal hydroxide, and water may be selectively controlled to help the desired end group modification. For example, the molar ratio of the N-alkylated cyclic amide to the metal hydroxide may range from about 50 to about 400, in some embodiments from about 100 to about 200, and in some embodiments, from about 120 to about 160. Likewise, the molar ratio of water to the metal hydroxide may range from about 10 to about 250, in some embodiments from about 30 to about 200, and in some embodiments, 60 to about 120. The ratio of the arylene sulfide polymer to the metal hydroxide may also be selectively controlled. For example, the weight of the arylene sulfide polymer to the moles of the metal hydroxide may be in a range of from about 0.2 to about 30, in some embodiments from about 0.5 to about 20, and in some embodiments, 1 to about 10.

Various embodiments of the present invention will now be described in further detail.

### I. Polymerization Process

The arylene sulfide polymer is generally formed using a multi-step polymerization process. In one embodiment, for instance, the process may include a first step during which a sulfur source is reacted with a dihaloaromatic compound to form an arylene sulfide prepolymer. The prepolymer may, for instance, have a weight average molecular weight of from about 3,000 to about 18,000 Daltons, in some embodiments from about 5,000 to about 17,000 Daltons, and in some embodiments, from about 10,000 to about 16,000 Daltons.

The sulfur source may be an alkali metal sulfide, such as lithium sulfide, sodium sulfide, sodium hydrosulfide, potassium sulfide, rubidium sulfide, cesium sulfide, etc., as well as derivatives, hydrates, or complexes thereof. For instance, a sodium sulfide hydrate may be prepared from sodium hydrogen sulfide and sodium hydroxide. The sulfur source may also be a complex that is formed by reacting an alkali metal sulfide with an organic amide solvent (e.g., N-methyl-2-pyrrolidone (NMP)). In certain embodiments, the alkali metal sulfide used to form such a complex may be sodium sulfide or a sodium sulfide hydrate prepared by reacting sodium hydrogen sulfide and sodium hydroxide. When a combination of alkali metal hydrogen sulfide and alkali metal hydroxide are used to form the alkali metal sulfide, the molar ratio of alkali metal hydroxide to alkali metal hydrogen sulfide may be between about 1.00 and about 1.03. Regardless, the resulting complex includes sodium methylaminobutyrate (“SMAB”) and sodium hydrogen sulfide (“NaSH”) (collectively referred to as “SMAB-NaSH”). One example of a reaction scheme that can be used to form the SMAB-NaSH complex is set forth below:

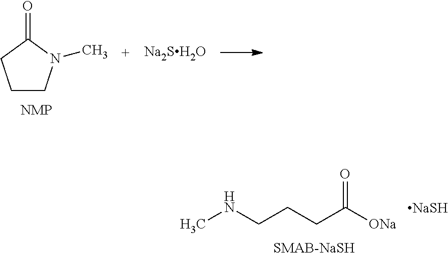

The dihaloaromatic compound may be, without limitation, an o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide or dihalodiphenyl ketone. Dihaloaromatic compounds may be used either singly or in any combination thereof. Specific exemplary dihaloaromatic compounds may include, without limitation, p-dichlorobenzene; m-dichlorobenzene; o-dichlorobenzene; 2,5-dichlorotoluene; 1,4-dibromobenzene; 1,4-dichloronaphthalene; 1-methoxy-2,5-dichlorobenzene; 4,4′-dichlorobiphenyl; 3,5-dichlorobenzoic acid; 4,4′-dichlorodiphenyl ether; 4,4′-dichlorodiphenylsulfone; 4,4′-dichlorodiphenylsulfoxide; and 4,4′-dichlorodiphenyl ketone. The halogen atom may be fluorine, chlorine, bromine or iodine, and two halogen atoms in the same dihalo-aromatic compound may be the same or different from each other. In one embodiment, o-dichlorobenzene, m-dichlorobenzene, p-dichlorobenzene or a mixture of two or more compounds thereof is used as the dihalo-aromatic compound. As is known in the art, it is also possible to use a monohalo and/or polyhalo (3 or more) compound, which is not necessarily aromatic, in combination with the dihaloaromatic compound to form end groups of the polyarylene sulfide or regulate the polymerization reaction and/or the molecular weight of the polyarylene sulfide. Nevertheless, the molar ratio of the dihaloaromatic compound to the sulfur source (e.g., SMAB-NaSH) employed during the first stage may be from about 0.5 to about 2.0, in some embodiments from about 0.8 to about 1.5, and in some embodiments, from about 1.0 to about 1.4.

The prepolymer is typically formed in the presence of an organic amide solvent. Exemplary organic amide solvents may include, without limitation, N-methyl-2-pyrrolidone (“NMP”), N-ethyl-2-pyrrolidone, N,N-dimethylformamide, N,N-dimethylacetamidem, N-methylcaprolactam, tetramethylurea, dimethylimidazolidinone, etc., as well as mixtures thereof. As noted above, the organic amide solvent may also be the N-alkyl cyclic amide that is used as a reactant to form the alkylamino carboxylic acid. The molar ratio of the sulfur source to the organic amide solvent (includes the organic solvent added and any solvent remaining from formation of the SMAB-NaSH complex) may, for instance, range from about 2.0 to about 4.0, in some embodiments from about 2.2 to about 3.0, and in some embodiments, from about 2.5 to about 3.0. The molar ratio of water to the sulfur source may likewise range from about 2.0 to about 4.0, in some embodiments from about 2.2 to about 3.0, and in some embodiments, from about 2.5 to about 3.0.

If desired, the reactants used during the first polymerization step (e.g., NMP, NaSH, and NaOH) may be subjected to a water removal step prior to introduction and/or reaction with the dihaloaromatic compound so that the water content does not inhibit the polymerization reaction. Water removal may be performed by heating in an inert gas atmosphere. The removed water may stem from the raw materials charged in the water removal step, an aqueous medium of the aqueous mixture, and water produced by a side reaction between the raw materials. The heating temperature in the water removal step is not particularly limited, but is typically about 300° C. or less, and in some embodiments, from about 100° C. to about 250° C., for a time period of from about 15 minutes to about 24 hours, and in some embodiments, from about 30 minutes to about 10 hours. The water removal is typically performed until the water content reaches a predetermined range. That is, in the water removal step, it is preferable to remove water until the water content is preferably from 0.5 to 2.4 mol with respect to 1.0 mol of sulfur source (hereinafter, also referred to as “charged sulfur source” or “effective sulfur source”) in a prepared mixture. After the optional water removal step, additional alkali metal hydroxide and/or water may also be added back into the reaction mixture to ensure an appropriate molar ratio of reactants for the polymerization reaction. In other words, the amount of any alkali metal hydroxide added to the reaction mixture can be determined by taking into account any hydrogen sulfide and alkali metal hydroxide generated during the water removal step. At the time of the initiation of the first polymerization step, for example, the water content is typically from about from 0.5 to about 2.4, in some embodiments from about 0.5 to about 2.0, and in some embodiments, from about 1 to about 1.5 moles per mole of the sulfur source.

As noted above, the reaction mixture used for the first polymerization step generally includes an organic solvent (e.g., NMP), sulfur source (e.g., NaSH), alkali metal hydroxide (e.g., NaOH), water, and dihaloaromatic compound (e.g., pDCB). The reaction mixture may also contain auxiliary agents, such as carboxylates, alkali metal chlorides, organic sulfonates, alkali metal sulfates, alkaline earth metal oxides, alkali metal phosphates, and alkaline earth metal phosphate, etc. The first polymerization reaction may generally be carried out in one or multiple steps within a temperature range from about 150° C. to about 260° C., in some embodiments from about 180° C. to about 255° C., and in some embodiments, from about 200° C. to about 250° C. The duration of the first polymerization stage may be, e.g., from about 0.5 to about 15 hours, or from about 1 to about 5 hours. The dihaloaromatic compound conversion ratio is typically from 50 to 98%, in some embodiments from 60 to 97%, in some embodiments from 65 to 96%, and in some embodiments, from 70 to 95%. The conversion ratio of the dihaloaromatic compound can be calculated by determining the amount of the dihaloaromatic compound remaining in the reaction mixture by gas chromatography and then performing a calculation based on this remaining amount of the dihaloaromatic compound, the charged amount of the dihaloaromatic compound, and the charged amount of the sulfur source.

After completion of the first polymerization step, a phase separation agent may optionally be added to the reaction mixture. The phase separation agent is not particularly limited and may include, for instance, water, organic carboxylic acids (e.g., isopentoic acid) or metal salts thereof, organic sulfonic acids or metal salts thereof, alkali metal halides, alkaline earth metal halides, alcohols, nonpolar solvents (e.g., n-decane), etc. The amount of the phase separation agent may vary depending on the type of compounds used, but is typically from about 1 to about 10 moles per kilogram of the organic amide solvent. For example, when using water as the phase separation agent, the content is typically from about 4 to about 20 miles per kilogram of the organic polar solvent, and the molar ratio of water to the organic amide solvent is typically from about 0.5 to about 3, in some embodiments from about 0.6 to about 2, and in some embodiments, from about 0.65 to about 1.5.

The second polymerization step is a process of continuing the polymerization reaction after any optional phase separation. In the second polymerization step, the polymerization reaction is continued in the presence of any optional phase separation agent. Specifically, adding a phase separation agent allows the polymerization reaction system (polymerization reaction mixture) to be phase-separated into the concentrated polymer phase (phase mainly containing the molten PAS) and the dilute polymer phase (phase mainly containing the organic polar solvent). The polymerization temperature in the second polymerization step is typically from about 245° C. to about 290° C., in some embodiments from about 250° C. to about 285° C., and in some embodiments, from about 255° C. to about 280° C. The polymerization temperature may be maintained at a fixed temperature or may be increased or decreased stepwise as necessary. The polymerization reaction time is typically in the range of from about 10 minutes to about 72 hours, and in some embodiments, from about 30 minutes to about 48 hours. The pH of the reaction mixture after the second polymerization step may be from 8 to 11, or may be from 9 to 10.5. The method for adjusting the pH of a reaction mixture is not particularly limited, and examples thereof include a method of adjusting the content of alkali metal hydroxide in the preparation step, or a method of adding alkali metal hydroxide, inorganic acid, and/or organic acid later.

To precipitate the resulting polymer after the second polymerization step (or after any additional other polymerization steps), the reaction mixture may be subjected to a cooling step. In the cooling step, the liquid phase containing the generated polymer may be cooled. For example, a coolant may be added to the reaction mixture at a temperature that is at least 5° C. higher than a maximum thickening temperature and lower than about 250° C. The cooling rate may vary, such as about 2.2° C./min or higher, in some embodiments about 2.4° C./min or higher, and in some embodiments, from about 2.6° C./min to about 6° C./min. Suitable coolants may included, for instance, water, organic polar solvents (e.g., organic amide solvents, such as NMP), etc., as well as combinations thereof. Apart the use of a coolant, other cooling methods may also be employed, such as using forced air cooling by an airflow generator, such as an electric fan or a circulator; circulation of a coolant in a jacket of a polymerization reactor; and refluxing of a gas phase in the reaction mixture by a reflux condenser. When employed, the content of the coolant in the reaction mixture may be from about 2.5 to about 6 moles, and in some embodiments, from about 3.5 to about 5 miles per 1 mol of the sulfur source.

After the reaction, a mixture is formed that may include the polymer along with various byproducts of the reaction, such as an organic solvent, unreacted dihaloaromatic compounds, salts formed as a by-product of the polymerization reaction, etc. For example, the amount of salts in the mixture may range from about 0.05 vol. % to about 0.25 vol. %, and in some embodiments, from about 0.1 vol. % to about 0.2 vol. %. Salts included in the reaction mixture may include those formed as a byproduct during the reaction as well as other salts added to the reaction mixture, for instance as a reaction promoter. The salts may be organic or inorganic, e.g., they may include any combination of organic or inorganic cations with organic or inorganic anions. They may be at least partially insoluble in the reaction medium and have a density different from that of the liquid reaction mixture. According to one embodiment, at least a portion of the salts in the reaction mixture may be removed therefrom, either before or cooling. For instance, the salts may be removed by use of screens or sieves as has been utilized in traditional separation processes. A salt/liquid extraction process may alternatively or additionally be utilized in separating the salt from the prepolymer mixture. In one embodiment, a hot filtration process may be employed in which the solution is filtered at a temperature at which the prepolymer is in solution and the salts are in the solid phase. According to one embodiment, a salt separation process may remove about 95% or more of the salts including in the prepolymer solution that exits the second reactor. For instance greater than about 99% of the salts may be removed from the prepolymer solution.

Once formed, the resulting polymer can be subjected to any of a variety of post treatments as is known in the art to purify or otherwise improve the characteristics of the polyarylene sulfide. For example, a second filtration process can be carried out that can remove any additional salt from the product mixture, for instance any salt formed as the molecular weight of the prepolymer is increased during the second polymerization reaction. In one embodiment, the polyarylene sulfide can be subjected to a crystallization process following the second polymerization reaction. The polyarylene sulfide may also be washed with a liquid media. For instance, the polyarylene sulfide may be washed with water, acetone, N-methyl-2-pyrrolidone, a salt solution, and/or an acidic media such as acetic acid or hydrochloric acid. The polyarylene sulfide can be washed in a sequential manner that is generally known to persons skilled in the art. The polyarylene sulfide can be subjected to a hot water washing process. The temperature of a hot water wash can be at or above about 100° C., for instance higher than about 120° C., higher than about 150° C., or higher than about 170° C. Generally, distilled water or deionized water can be used for hot water washing. In one embodiment, a hot water wash can be conducted by adding a predetermined amount of the polyarylene sulfide to a predetermined amount of water and heating the mixture under stirring in a pressure vessel. By way of example, a bath ratio of up to about 200 grams of polyarylene sulfide per liter of water can be used. Following the hot water wash, the polyarylene sulfide can be washed several times with warm water, maintained at a temperature of from about 10° C. to about 100° C. A wash can be carried out in an inert atmosphere to avoid deterioration of the polymer.

In one embodiment, organic solvent washing can be combined with hot water washing and/or warm water washing. Likewise, a washing solution can be employed that a combination of water and an organic solvent (e.g., N-methyl pyrrolidone). For example, the solution may contain water (e.g., deionized water) in an amount of from about 30 wt. % to about 70 wt. %, in some embodiments from about 35 wt. % to about 65 wt. %, and in some embodiments, from about 40 wt. % to about 60 wt. %. The washing solution also contains the organic solvent in an amount of from about 30 wt. % to about 70 wt. %, in some embodiments from about 35 wt. % to about 65 wt. %, and in some embodiments, from about 40 wt. % to about 60 wt. %. When a high-boiling-point organic solvent such as N-methylpyrrolidone is used, the residual organic solvent can be removed by washing with water or warm water after the organic solvent washing, and distilled water or deionized water can be used for this washing.

### II. End Group Modification

The end-group modifying compound of the present invention may generally be reacted with the prepolymer and/or polymer, such as described above, during and/or after polymerization. In certain embodiments, for example, the end-group modifying compound may be reacted with the prepolymer after the first step of polymerization. In another embodiment, the end-group modifying compound may be reacted with the polymer after the second step of polymerization. When reacted after polymerization, the end-group modifying compound may be reacted with the polymer just after polymerization (e.g., before precipitation) and/or after any steps of precipitation, purification, filtration, etc. In embodiments in which the end-group compound is formed in situ during the polymerization process, for example, an N-alkylated cyclic amide (e.g., NMP) and water may already be present within the reaction mixture. In this manner, for example, a metal hydroxide (e.g., sodium hydroxide) may be added thereto and heated at the temperature and for the time period noted above to initiate the reaction of the end groups. Of course, as noted above, in situ formation of the end group-modifying compound may also be conducted simply by pre-blending one or more of the metal hydroxide, N-alkylated cyclic amide, and water and then heating in the blend in the presence of the arylene sulfide polymer.

The resulting polyarylene sulfide may be linear, semi-linear, branched, or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. The resulting polyarylene sulfide may contain repeating units of the formula (1):

—[(Ar¹)ₙ—X]ₘ—[(Ar²)ᵢ—Y]ᵢ—[(Ar³)ₖ—Z]ᵢ—[(Ar⁴)ₒ—W]ₚ— (I)

wherein Ar¹, Ar², Ar³, and Ar⁴ are the same or different and are arylene units of 6 to 18 carbon atoms; W, X, Y, and Z are the same or different and are bivalent linking groups selected from —SO₂—, —S—, —SO—, —CO—, —O—, —COO— or alkylene or alkylidene groups of 1 to 6 carbon atoms and wherein at least one of the linking groups is —S—; and n, m, i, j, k, l, o, and p are independently zero or 1, 2, 3, or 4, subject to the proviso that their sum total is not less than 2. The arylene units Ar¹, Ar², Ar³, and Ar⁴ may be selectively substituted or unsubstituted. Advantageous arylene systems are phenylene, biphenylene, naphthylene, anthracene and phenanthrene. The polyarylene sulfide can typically include more than about 30 mol %, more than about 50 mol %, or more than about 70 mol % arylene sulfide (-AR-S—) units. In one embodiment the polyarylene sulfide includes at least 85 mol % sulfide linkages attached directly to two aromatic rings. In one embodiment, the polyarylene sulfide can be a polyphenylene sulfide, defined herein as containing the phenylene sulfide structure —(C₆H₄—S)ₙ— (wherein n is an integer of 1 or more) as a component thereof.

As noted above, the polyarylene sulfide resin obtained after treatment with an end group-modifying compound can have a high degree of reactivity with silane compounds. In this regard, the resin may exhibit a “Reactivity Value” of from about 2 to about 4, in some embodiments from about 2.1 to about 3.8, and in some embodiments, from about 2.4 to about 3.5. The “Reactivity Value” is defined as the ratio of the melt viscosity of the resin following the addition of an aqueous solution containing 0.5 wt. % of aminopropyltetraethoxysilane (“MV₂”) to the melt viscosity of the resin prior to treatment with the aqueous solution (“MV₁”). The initial melt viscosity (MV₁) may, for example, range from about 50 to about 2,000 poise, in some embodiments from about 60 to about 1,300 poise, in some embodiments from about 80 to about 1,200 poise, and in some embodiments, from about 100 to about 1,000 poise, as determined at a temperature of 310° C. and a shear rate of 1,200 s⁻¹. After treatment with the silane solution, the melt viscosity (MV₁) may, for example, range from about 200 to about 5,000 poise, in some embodiments from about 300 to about 3,500 poise, and in some embodiments, from about 500 to about 2,000 poise, as determined at a temperature of 310° C. and a shear rate of 1,200 s⁻¹.

In addition to having a relatively high compatibility with silane compounds, the polyarylene sulfide resin can also exhibit a variety of other beneficial properties. For instance, the polyarylene sulfide resin may have a relatively low yellowness index, such as about 12 or less, in some embodiments about 10 or less, and in some embodiments, from about 1 to about 9, such as determined according to the procedure of ASTM E313 (illuminant D65; 10 degree observer). Beneficially, the polyarylene sulfides can have a low yellowness index as formed, i.e., neat, without the inclusion of any additives to the polymer. The bulk density of the polymer can generally be between about 0.2 grams per cubic centimeter (g/cm³) and about 1.5 g/cm³, for instance between about 0.3 g/cm³ and about 1 g/cm³ or between about 0.5 g/cm³ and about 0.9 g/cm³ as determined according to ISO Test No. 1183 (technically equivalent to ASTM D792). The volatile content of the polymer can be about 0.5 wt. % or less, for instance about 0.3 wt. % or less, based upon weight loss following vacuum drying. The polyarylene sulfide resin can also have low impurities, for instance less than about 10,000 ppm solvent, less than about 1100 ppm dihaloaromatic monomer, less than about 100 ppm sodium chloride, and/or less than about 0.5% ash. The thermal properties of the polyarylene sulfide can also be beneficial. For instance, the crystallization temperature, T_{c2}, can be between about 190° C. and about 300° C., for example between about 200° C. and about 265° C., as determined by differential scanning calorimetry, for instance as described in ISO Standard 10350. The glass transition temperature can be between about 90° C. and about 100° C., for instance between about 90° C. and about 95° C. as determined according to ISO standard 11357. The melting temperature can be between about 270° C. and about 300° C. as determined according to ISO standard 11357.

The resulting polyarylene sulfide resin may also have a good particle size distribution. For instance, the di value can be from about 15 micrometers to about 30 micrometers, the d₅₀ value can be from about 70 micrometers to about 100 micrometers, and the d₅₀ value can be from about 100 micrometers to about 150 micrometers. The median diameter of the particles can be from about 100 micrometers to about 1000 micrometers. In one embodiment, about 95% or more of the particles can be between about 50 micrometers and about 150 micrometers in particle size. For instance, about 0.5 wt. % or less of the particles can have a diameter of greater than about 2800 micrometers, and about 10 wt. % or less of the polymers can have a diameter of less than about 110 micrometers. Particle size analysis can be carried out via laser diffraction of sample particles according to know methodology. The polyarylene sulfide can also exhibit a high degree of porosity. For instance, the polyarylene sulfide can exhibit a pore area of about 30 m²/g or more, and in some embodiments from about 35 m²/g to about 60 m²/g. Pore area can be determined according to DIN 66 133. This method is based on the intrusion of mercury as a non-wetting liquid into a solid and porous material under pressure. Depending on pore size a specific pressure has to be applied in order to push mercury into the pores against the opposing force of the mercury's surface tension. By registration of the needed pressure pore size and porosity can be calculated via the Washburn equation.

### III. Polymer Composition

As noted above, the end group-modified polyarylene sulfide resins may have an increased degree of compatibility with silanes, which can provide a variety of benefits to polymer compositions containing such resins. For example, the polymer composition may contain inorganic fibers (e.g., glass fibers) having a silane-containing sizing composition and/or separate silane coupling agent. In this regard, because the modified polyarylene sulfide resins described herein can exhibit enhanced compatibility with such components, the resulting polymer composition may have more uniform properties, particularly when exposed to extreme conditions, such as high temperatures, low temperatures, or at a high degree of humidity.

Various embodiments of such compositions will now be described in more detail.

### A. Polymer Matrix

The polymer composition generally contains a polymer matrix, which may constitute from about 40 wt. % to about 90 wt. %, in some embodiments from about 45 wt. % to about 90 wt. %, and in some embodiments, from about 50 wt. % to about 70 wt. % of the polymer composition. The polymer matrix contains at least one modified polyarylene sulfide resin as described herein. For example, such modified polyarylene sulfide resins typically constitute from about 50 wt. % to 100 wt. %, in some embodiments from about 70 wt. % to 100 wt. %, and in some embodiments, from about 90 wt. % to 100 wt. % of the polymer matrix (e.g., 100 wt. %).

### B. Inorganic Fibers

As noted, inorganic fibers may be employed in the polymer composition to improve the thermal and mechanical properties of the composition. The inorganic fibers typically have a high degree of tensile strength relative to their mass. For example, the ultimate tensile strength of the fibers (determined in accordance with ASTM D822/D822M-13 (2018)) is typically from about 1,000 to about 15,000 Megapascals (“MPa”), in some embodiments from about 2,000 MPa to about 10,000 MPa, and in some embodiments, from about 3,000 MPa to about 6,000 MPa. Further, although the fibers may have a variety of different sizes, fibers having a certain size can help improve the mechanical properties of the resulting polymer composition. The inorganic fibers may, for example, have a nominal diameter of from about 5 micrometers to about 40 micrometers, in some embodiments from about 6 micrometers to about 30 micrometers, in some embodiments from about 8 micrometers to about 20 micrometers, and in some embodiments from about 9 micrometers to about 15 micrometers. The fibers (after compounding) may also have a relatively high aspect ratio (average length (μm) divided by nominal diameter (μm)), such as about 2 or more, in some embodiments from about 4 to about 100, in some embodiments from about 5 to about 50, and in some embodiments, from about 8 to about 40 are particularly beneficial. Such fibers may, for instance, have a volume average length (after compounding) of about 10 micrometers or more, in some embodiments about 25 micrometers or more, in some embodiments from about 50 micrometers or more to about 800 micrometers or less, and in some embodiments from about 60 micrometers to about 500 micrometers. The relative amount of the fibers may also be selectively controlled to help achieve the desired mechanical and thermal properties without adversely impacting other properties of the composition, such as its flowability. The inorganic fibers may, for instance, constitute from about 30 to about 120 parts by weight, in some embodiments from about 40 to about 110 parts by weight, and in some embodiments, from about 50 to about 100 parts by weight per 100 parts by weight of the polymer matrix. For example, the inorganic fibers may constitute from about 20 wt. % to about 60 wt. %, in some embodiments from about 25 wt. % to about 55 wt. %, and in some embodiments, from about 30 wt. % to about 50 wt. % of the polymer composition.

In addition to the size, strength, and relative concentration, the composition of the inorganic fibers may optionally be selectively controlled to achieve better hydrolytic stability, particularly at high temperatures. Generally speaking, the inorganic fibers may be formed from materials that are generally insulative in nature, such as glass, ceramics (e.g., alumina or silica), etc. Glass fibers are particularly suitable, such as E-glass, E-CR glass, A-glass, C-glass, D-glass, AR-glass, R-glass, S1-glass, S2-glass, etc., as well as mixtures of any of the foregoing. Glass fibers that are generally free of boron (e.g., E-CR glass fibers) are particularly suitable. In certain embodiments, the glass fibers may include silica (SiO₂), alumina (Al₂O₃), and oxides of calcium and magnesium (e.g., CaO, MgO, etc.), but are generally free of boron and optionally fluorides. For example, the glass fibers may contain boron in a concentration of about 1 wt. % or less, in some embodiments about 0.5 wt. % or less, in some embodiment about 0.1 wt. % or less (e.g., 0 wt. %), relative to the total weight of the glass fibers. The glass fibers may likewise contain fluorides in a concentration of about 0.5 wt. % or less, in some embodiments about 0.2 wt. % or less, in some embodiment about 0.01 wt. % or less (e.g., 0 wt. %), relative to the total weight of the glass fibers. Boron concentration and fluoride concentration can be measured by inductively coupled plasma-atomic emission spectrometry. In the absence of boric oxide, the glass fibers may further include titanium dioxide (TiO₂) to reduce melt viscosity. For example, the concentration of titanium in the glass fibers may be about 0.1 wt. % to about 1 wt. %, and in some embodiments, from about 0.15 wt. % to about 0.5 wt. % of the total weight of the glass fibers. Besides titanium dioxide, the glass fibers can further include potassium oxide (K₂O) and/or lithium oxide (Li₂O) as fluxing agents. For example, the concentration of potassium in the glass fibers may be about 0.2 wt. % to about 1 wt. %, and in some embodiments, from about 0.3 wt. % to about 0.5 wt. % of the total weight of the glass fibers. The concentration of lithium in the glass fibers may also be about 0.1 wt. % to about 1 wt. %, and in some embodiments, from about 0.2 wt. % to about 0.5 wt. % of the total weight of the glass fibers. The glass fibers may also have a relatively low amount of sodium oxide (Na₂O). For example, the concentration of sodium in the glass fibers may be about 0.1 wt. % to about 1 wt. %, and in some embodiments, from about 0.2 wt. % to about 0.5 wt. % of the total weight of the glass fibers. Titanium, potassium, lithium, and sodium concentrations can be measured by ICP-AES. In one particular embodiment, the glass fibers may contain silica in an amount of from about 57.5 wt. % to about 59.5 wt. %, alumina in an amount of from about 17 wt. % to about 20 wt. %, calcium oxide in an amount of from about 11 wt. % to about 13.5 wt. %, magnesium oxide in an amount of from about 8.5 wt. % to about 12.5 wt. %, and optionally sodium oxide, potassium oxide, lithium oxide, and/or titanium oxide. Other oxides may also be employed, such as iron oxide (Fe₂O₃).

If desired, the inorganic fibers may contain a sizing composition coated thereon to help improve hydrolytic resistance. The sizing composition may include an organosilane compound that is capable of forming Si—O—Si covalent bonds between the glass fiber surface and silanols obtained by hydrolysis of the silane compound, as well as between adjacent silanol groups. The resulting covalent bonds forms a crosslinked structure at the surface of the fibers that can enhance resistance to hydrolysis. Such organosilane compounds may, for instance, constitute from about 2 wt. % to about 40 wt. %, in some embodiments from about 2.5 wt. % to about 20 wt. %, and in some embodiments, from about 5 wt. % to about 15 wt. % of the solids content of the sizing composition (i.e., excluding water). The organosilane compound may, for example, be any alkoxysilane as is known in the art, such as vinlyalkoxysilanes, epoxyalkoxysilanes, aminoalkoxysilanes, mercaptoalkoxysilanes, and combinations thereof. In one embodiment, for instance, the organosilane compound may have the following general formula:

R⁵—Si—(R⁶)₃,
wherein,
R⁵ is a sulfide group (e.g., —SH), an alkyl sulfide containing from 1 to 10 carbon atoms (e.g., mercaptopropyl, mercaptoethyl, mercaptobutyl, etc.), alkenyl sulfide containing from 2 to 10 carbon atoms, alkynyl sulfide containing from 2 to 10 carbon atoms, amino group (e.g., NH₂), aminoalkyl containing from 1 to 10 carbon atoms (e.g., aminomethyl, aminoethyl, aminopropyl, aminobutyl, etc.); aminoalkenyl containing from 2 to 10 carbon atoms, aminoalkynyl containing from 2 to 10 carbon atoms, and so forth; and
R⁶ is an alkoxy group of from 1 to 10 carbon atoms, such as methoxy, ethoxy, propoxy, and so forth.

Aminosilane compounds are particularly suitable and may include monomeric or oligomeric (<6 units) silanes. Aminotrialkoxysilanes may be employed in certain embodiments to form a three dimensional network of Si—O—Si covalent bonds at the surface and around the surface of the fibers. Aminodialkoxysilanes may likewise be employed in certain embodiments to form a hairlike structure on the surface of the fibers. While not necessarily forming a three-dimensional crosslinked protective sheath around the fibers, the dialkoxysilanes may nevertheless facilitate impregnation of the fiber bundles and wetting of the individual fibers by a polymer melt, as well as reduce the hydrophilicity of the surface of the fibers believed to contribute to resistance to hydrolysis. Thus, it may be desirable to employ trialkoxysilanes, dialkoxysilanes, or mixtures thereof in the sizing composition. Specific examples of suitable aminosilanes may include, for instance, aminodialkoxysilanes, such as γ-aminopropylmethyldiethoxysilane, N-β-(Aminoethyl)-gamma-aminopropylmethyldimethoxysilane, N-β-(Aminoethyl)-γ-aminopropyl-methyldimethoxysilane, N-β-(Aminoethyl)-γ-aminoisobutylmethyldimethoxy-silane, γ-aminopropylmethyldimethoxysilane, N-β-(Aminoethyl)-γ-aminopropyl-methyldiethoxysilane, etc.; aminotrialkoxysilanes, such as γ-aminopropyltriethoxysilane, γ-aminopropyltri-methoxysilane, N-β-(Aminoethyl)-γ-aminopropyl-trimethoxysilane, N-β-(Aminoethyl)-γ-aminopropyltriethoxysilane, diethylene-triaminopropyltrimethoxysilane, Bis-(γ-trimethoxysilylpropyl) amine, N-phenyl-γ-aminopropyltrimethoxysilane, γ-amino-3,3-dimethylbutyltrimethoxysilane, γ-aminobutyltriethoxysilane, etc.; as well as mixtures of any of the foregoing.

In addition to an organosilane compound, the sizing composition may also contain one or more functionalized compounds that may be crosslinked to form a three-dimensional polymer network that can further enhance the hydrolytic resistance of the fibers. When employed, such functionalized compounds may constitute from about 5 wt. % to about 90 wt. %, in some embodiments from about 10 wt. % to about 80 wt. %, and in some embodiments, from about 15 wt. % to about 70 wt. % of the solids content of the sizing composition (i.e., excluding water). In one embodiment, for instance, the functionalized compound may be a blocked isocyanate. As used herein, the term “blocked isocyanate” refers to an isocyanate in which one or more of the isocyanate groups of an organic polyisocyanate have been reversibly reacted with a blocking agent. In this manner, the resulting blocked (partially or fully) isocyanate groups are stable to active hydrogens at ambient temperature but can become deblocked at elevated temperatures so that they are reactive with active hydrogens, such as, for example, at temperatures between about 90° C. to about 210° C., in some embodiments between about 105° C. to about 180° C., and in some embodiments, between about 125° C. to about 170° C. Representative examples of suitable organic polyisocyanates include aliphatic isocyanates (e.g., trimethylene diisocyanate, tetramethylene diisocyanate, hexamethylene diisocyanate, butylidene diisocyanate, etc.); (cyclo)aliphatic isocyanates (e.g., isophorone diisocyanate (IPDI), 4,4′-diisocyanato-dicyclohexylmethane (HMDI), etc.); aromatic isocyanates (e.g., p-phenylene diisocyanate); aliphatic-aromatic isocyanates (e.g., 4,4′-diphenylene methane diisocyanate, 2,4- or 2,6-tolylene diisocyanate, etc.); as well as mixtures thereof. Representative examples of suitable blocking agents include, but are not limited to, oximes, such as methyl ethyl ketoxime, acetone oxime and cyclohexanone oxime; lactams, such as epsilon-caprolactam; alcohols; malonic esters; alkyl acetoacetates, triazoles; pyrazoles; phenols; amines, such as benzyl t-butylamine; as well as mixtures thereof. In one embodiment, the blocked isocyanate is a blocked cycloaliphatic polyisocyanate.

The functionalized compound may also include polymers that contain an anhydride and/or carboxylic functionality. Examples of such polymers may include, for instance, a copolymer of ethylene-maleic anhydride, butadiene-maleic anhydride, isobutylene-maleic anhydride acrylate-maleic anhydride, polyacrylic acid, etc. When employed, such anhydride- and/or carboxylic-functionalized polymers may constitute from about 5 wt. % to about 60 wt. %, in some embodiments from about 10 wt. % to about 40 wt. %, and in some embodiments, from about 15 wt. % to about 30 wt. % of the solids content of the sizing composition (i.e., excluding water). Other functionalized polymers may also be employed, either alone or in combination with polymers that contain an anhydride and/or carboxylic functionality. In certain embodiments, for example, an epoxy-functionalized polymer may be employed, such as epoxy phenol novolac (EPN), epoxy cresol novolac (ECN), etc. When employed, such epoxy-functionalized polymers may constitute from about 30 wt. % to about 90 wt. %, in some embodiments from about 40 wt. % to about 80 wt. %, and in some embodiments, from about 50 wt. % to about 70 wt. % of the solids content of the sizing composition (i.e., excluding water). In certain embodiments, combinations of such functionalized polymers may also be employed. In fact, it is believed that a dense crosslinked sheath can formed around the inorganic fibers by reaction of epoxy groups with maleic anhydride and/or carboxylic groups.

Apart from organosilane and functionalized compounds, the sizing composition may also contain a film-forming agent that can help protect the fibers from damage during processing and promote compatibility of the fibers with the polymer matrix. Particularly suitable film forming agents are polymers, such as polyurethanes, (meth)acrylate polymers, epoxy resin emulsions (e.g., based on epoxy bisphenol A or epoxy bisphenol F), epoxy ester resins, epoxy urethane resins, polyamides, etc., as well as mixtures of any of the foregoing. In one particular embodiment, for example, the film forming agent may include a polymer that is also functionalized, such as a polymer that includes a blocked isocyanate functionality as described above. Examples of such functionalized film-forming agents may include polyester-based and polyether-based polyurethanes that include a blocked isocyanate. When employed, such film forming agents may constitute from about 0.1 wt. % to about 50 wt. %, in some embodiments from about 1 wt. % to about 40 wt. %, and in some embodiments, from about 5 wt. % to about 30 wt. % of the solids content of the sizing composition (i.e., excluding water). Other additives may also be employed in the sizing composition, such as pH adjusters, lubricants, antistatic agents, antifoaming agents, crosslinking agents, etc.

The sizing composition may be applied to the surface of the inorganic fibers in a variety of different ways. For example, the sizing composition may be applied as the fibers are formed out of a bushing. The entire composition may also be applied to the fibers in a single step, or one or more components of the sizing composition may be applied separately. In one embodiment, for example, a two-stage application process may be employed in which a polymer containing an anhydride and/or carboxylic acid functionality is applied in a first stage and a polymer containing an epoxy functionality is applied in a second stage. In this manner, the polymers may be crosslinked together only after application to the fiber surface. Other components of the sizing composition may be applied separately or in combination with one or both of the polymers. Notwithstanding the particular process employed, one or more solvents (e.g., water) may be added to the components of the sizing composition during application to aid in the coating process. Once coated, the fibers may be dried to remove the solvent. In this regard, the moisture content of the coated fibers is typically about 0.5 wt. % or less, in some embodiments about 0.2 wt. % or less, and in some embodiments about 0.1 wt. % or less. Likewise, the amount of the sizing composition employed is typically from about 0.3 wt. % to about 1.2 wt. %, in some embodiments from about 0.4 wt. % to about 1 wt. %, and in some embodiments, from about 0.5 wt. % to about 0.8 wt. % based on the total weight of the coated fibers.

### C. Organosilane Compound

As noted above, in addition to the components noted above, the polymer composition may also contain a variety of other optional components to help improve its overall properties. In one embodiment, for instance, an organosilane compound may be employed in the polymer composition, such as in an amount of from about 0.1 to about 8 parts, in some embodiments from about 0.3 to about 5 parts, and in some embodiments, from about 0.5 to about 3 parts by weight per 100 parts by weight of the polyarylene sulfide(s). For example, organosilane compounds can constitute from about 0.01 wt. % to about 3 wt. %, in some embodiments from about 0.02 wt. % to about 2 wt. %, and in some embodiments, from about 0.05 to about 1 wt. % of the polymer composition.

The organosilane compound may be the same or different than the organosilane compound optionally employed in the sizing composition for the inorganic fibers. In one embodiment, for example, the organosilane compound may be an alkoxysilane, such as described above. Some representative examples of alkoxysilane compounds that may be employed include mercaptopropyl trimethyoxysilane, mercaptopropyl triethoxysilane, aminopropyl triethoxysilane, aminoethyl triethoxysilane, aminopropyl trimethoxysilane, aminoethyl trimethoxysilane, ethylene trimethoxysilane, ethylene triethoxysilane, ethyne trimethoxysilane, ethyne triethoxysilane, aminoethylaminopropyltrimethoxysilane, 3-aminopropyl triethoxysilane, 3-aminopropyl trimethoxysilane, 3-aminopropyl methyl dimethoxysilane or 3-aminopropyl methyl diethoxysilane, N-(2-aminoethyl)-3-aminopropyl trimethoxysilane, N-methyl-3-aminopropyl trimethoxysilane, N-phenyl-3-aminopropyl trimethoxysilane, bis(3-aminopropyl) tetramethoxysilane, bis(3-aminopropyl) tetraethoxy disiloxane, γ-aminopropyltrimethoxysilane, γ-aminopropyltriethoxysilane, γ-aminopropylmethyldimethoxysilane, γ-aminopropylmethyldiethoxysilane, N-(β-aminoethyl)-γ-aminopropyltrimethoxysilane, N-phenyl-γ-aminopropyltrimethoxysilane, γ-diallylaminopropyltrimethoxysilane, γ-diallylaminopropyltrimethoxysilane, etc., as well as combinations thereof. Particularly suitable organosilane compounds are 3-aminopropyltriethoxysilane and 3-mercaptopropyltrimethoxysilane.

### D. Other Optional Components

An impact modifier may also be employed within the polymer composition. When employed, the impact modifier(s) may constitute from about 1 to about 20 parts, in some embodiments from about 2 to about 15 parts, and in some embodiments, from about 5 to about 10 parts by weight per 100 parts by weight of the polyarylene sulfide(s). For example, the impact modifiers may constitute from about 0.1 wt. % to about 20 wt. %, in some embodiments from about 0.5 wt. % to about 15 wt. %, and in some embodiments, from about 1 wt. % to about 10 wt. % of the polymer composition.

Examples of suitable impact modifiers may include, for instance, polyepoxides, polyurethanes, polybutadiene, acrylonitrile-butadiene-styrene, polyamides, block copolymers (e.g., polyether-polyamide block copolymers), etc., as well as mixtures thereof. In one embodiment, an olefin copolymer is employed that is “epoxy-functionalized” in that it contains, on average, two or more epoxy functional groups per molecule. The copolymer generally contains an olefinic monomeric unit that is derived from one or more α-olefins. Examples of such monomers include, for instance, linear and/or branched α-olefins having from 2 to 20 carbon atoms and typically from 2 to 8 carbon atoms. Specific examples include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin monomers are ethylene and propylene. The copolymer may also contain an epoxy-functional monomeric unit. One example of such a unit is an epoxy-functional (meth)acrylic monomeric component. As used herein, the term “(meth)acrylic” includes acrylic and methacrylic monomers, as well as salts or esters thereof, such as acrylate and methacrylate monomers. For example, suitable epoxy-functional (meth)acrylic monomers may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate. Other suitable monomers may also be employed to help achieve the desired molecular weight.

Of course, the copolymer may also contain other monomeric units as is known in the art. For example, another suitable monomer may include a (meth)acrylic monomer that is not epoxy-functional. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. In one particular embodiment, for example, the copolymer may be a terpolymer formed from an epoxy-functional (meth)acrylic monomeric component, α-olefin monomeric component, and non-epoxy functional (meth)acrylic monomeric component. The copolymer may, for instance, be poly(ethylene-co-butylacrylate-co-glycidyl methacrylate), which has the following structure:

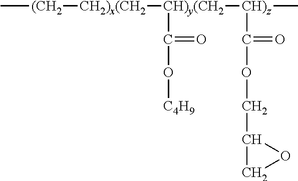

wherein, x, y, and z are 1 or greater.

The relative portion of the monomeric component(s) may be selected to achieve a balance between epoxy-reactivity and melt flow rate. More particularly, high epoxy monomer contents can result in good reactivity with the polyarylene sulfide, but too high of a content may reduce the melt flow rate to such an extent that the copolymer adversely impacts the melt strength of the polymer blend. Thus, in most embodiments, the epoxy-functional (meth)acrylic monomer(s) constitute from about 1 wt. % to about 20 wt. %, in some embodiments from about 2 wt. % to about 15 wt. %, and in some embodiments, from about 3 wt. % to about 10 wt. % of the copolymer. The α-olefin monomer(s) may likewise constitute from about 55 wt. % to about 95 wt. %, in some embodiments from about 60 wt. % to about 90 wt. %, and in some embodiments, from about 65 wt. % to about 85 wt. % of the copolymer. When employed, other monomeric components (e.g., non-epoxy functional (meth)acrylic monomers) may constitute from about 5 wt. % to about 35 wt. %, in some embodiments from about 8 wt. % to about 30 wt. %, and in some embodiments, from about 10 wt. % to about 25 wt. % of the copolymer. The resulting melt flow rate is typically from about 1 to about 30 grams per 10 minutes (“g/10 min”), in some embodiments from about 2 to about 20 g/10 min, and in some embodiments, from about 3 to about 15 g/10 min, as determined in accordance with ASTM D1238-20 at a load of 2.16 kg and temperature of 190° C.

If desired, additional impact modifiers may also be employed in combination with the epoxy-functional impact modifier. For example, the additional impact modifier may include a block copolymer in which at least one phase is made of a material that is hard at room temperature but fluid upon heating and another phase is a softer material that is rubber-like at room temperature. For instance, the block copolymer may have an A-B or A-B-A block copolymer repeating structure, where A represents hard segments and B is a soft segment. Non-limiting examples of impact modifiers having an A-B repeating structure include polyamide/polyether, polysulfone/polydimethylsiloxane, polyurethane/polyester, polyurethane/polyether, polyester/polyether, polycarbonate/polydimethylsiloxane, and polycarbonate/polyether. Triblock copolymers may likewise contain polystyrene as the hard segment and either polybutadiene, polyisoprene, or polyethylene-co-butylene as the soft segment. Similarly, styrene butadiene repeating co-polymers may be employed, as well as polystyrene/polyisoprene repeating polymers. In one particular embodiment, the block copolymer may have alternating blocks of polyamide and polyether. Such materials are commercially available, for example from Atofina under the PEBAX™ trade name. The polyamide blocks may be derived from a copolymer of a diacid component and a diamine component or may be prepared by homopolymerization of a cyclic lactam. The polyether block may be derived from homo- or copolymers of cyclic ethers such as ethylene oxide, propylene oxide, and tetrahydrofuran.

A siloxane polymer may also be employed in the polymer composition. Such siloxane polymer(s) typically constitute from about 0.05 to about 10 parts, in some embodiments from about 0.1 to about 8 parts, and in some embodiments, from about 0.5 to about 5 parts by weight per 100 parts by weight of the polyarylene sulfide(s). For example, siloxane polymer(s) may constitute from about 0.05 wt. % to about 15 wt. %, in some embodiments from about 0.5 wt. % to about 10 wt. %, and in some embodiments, from about 1 wt. % to about 8 wt. % of the polymer composition.

The siloxane polymer can, among other things, improve the processing of the composition, such as by providing better mold filling, internal lubrication, mold release, etc. Further, it is also believed that the siloxane polymer is less likely to migrate or diffuse to the surface of the composition, which further minimizes the likelihood of phase separation and further assists in dampening impact energy. The siloxane polymer generally has a high molecular weight, such as a weight average molecular weight of about 100,000 grams per mole or more, in some embodiments about 200,000 grams per mole or more, and in some embodiments, from about 500,000 grams per mole to about 2,000,000 grams per mole. The siloxane polymer may also have a relatively high kinematic viscosity at 25° C., such as about 10,000 centistokes or more, in some embodiments about 30,000 centistokes or more, and in some embodiments, from about 50,000 to about 50×10⁶ centistokes, such as from about 1×10⁶ to 50×10⁶ centistokes. The viscosity of a siloxane polymer can be determined according to ASTM D445-21.

Any of a variety of high molecular weight siloxane polymers may generally be employed in the polymer composition. A high molecular weight siloxane polymer generally includes siloxane-based monomer residue repeating units. As used herein, “siloxane” denotes a monomer residue repeat unit having the structure:

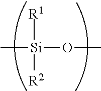

where R¹ and R² are independently hydrogen or a hydrocarbyl moiety, which is known as an “M” group in silicone chemistry.

The silicone may include branch points such as

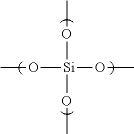

which is known as a “Q” group in silicone chemistry, or

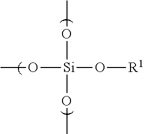

which is known as “T” group in silicone chemistry.

As used herein, the term “hydrocarbyl” denotes a univalent group formed by removing a hydrogen atom from a hydrocarbon (e.g., alkyl groups, such as ethyl, or aryl groups, such as phenyl). In one or more embodiments, a siloxane monomer residue can be any dialkyl, diaryl, dialkaryl, or diaralkyl siloxane, having the same or differing alkyl, aryl, alkaryl, or aralkyl moieties. In an embodiment, each of R¹ and R² is independently a C₁ to C₂₀, C₁ to C₁₂, or C₁ to C₆ alkyl (e.g., methyl, ethyl, propyl, butyl, etc.), aryl (e.g., phenyl), alkaryl, aralkyl, cycloalkyl (e.g., cyclopentyl), arylenyl, alkenyl, cycloalkenyl (e.g., cyclohexenyl), alkoxy (e.g., methoxy), etc., as well as combinations thereof. In various embodiments, R¹ and R² can have the same or a different number of carbon atoms. In various embodiments, the hydrocarbyl group for each of R¹ and R² is an alkyl group that is saturated and optionally straight-chain. Additionally, the alkyl group in such embodiments can be the same for each of R¹ and R² of a polymer chain. Non-limiting examples of alkyl groups suitable for use in R¹ and R² include methyl, ethyl, 1-propyl, 2-propyl, 1-butyl, isobutyl, t-butyl, or combinations of two or more thereof.

Additionally, the siloxane polymer can contain various terminating groups as an R¹ and/or R² group, such as vinyl groups, hydroxyl groups, hydrides, isocyanate groups, epoxy groups, acid groups, halogen atoms, alkoxy groups, acyloxy groups, ketoximate groups, amino groups, amido groups, acid amido groups, amino-oxy groups, mercapto groups, alkenyloxy groups, alkoxyalkoxy groups, or aminoxy groups as well as combinations thereof. Additionally, a polymer composition can include a mixture of two or more siloxane polymers.

In some embodiments, a high molecular weight siloxane polymer can be proved by copolymerizing multiple siloxane polymers having a low weight average molecular weight (e.g., a molecular weight of less than 100,000 grams per mole) with polysiloxane linkers. In one particular embodiment, for instance, the resin may be formed by copolymerizing one or more low molecular siloxane polymer(s) with a linear polydiorganosiloxane linker, such as described in U.S. Pat. No. 6,072,012 to Juen, et al. A substantially linear polydiorganosiloxane linker may have the following general formula:

(R³₍₃₋ₚ₎R⁴ₚSiO_{1/2})(R³₂SiO_{2/2})ₓ((R³R⁴SiO_{2/2})(R³₂SiO_{2/2})ₓ)_{y}(R³₍₃₋ₚ₎R⁴ₚSiO_{1/2})
wherein,
each R³ is a monovalent group independently selected from the group consisting of alkyl, aryl, and arylalkyl groups;
each R⁴ is a monovalent group independently selected from the group consisting of hydrogen, hydroxyl, alkoxy, oximo, alkyloximo, and aryloximo groups, wherein at least two R⁵ groups are typically present in each molecule and bonded to different silicon atoms;
p is 0, 1, 2, or 3;
x ranges from 0 to 200, and in some embodiments, from 0 to 100; and
y ranges from 0 to 200, and in some embodiments, from 0 to 100.

In certain embodiments, the siloxane polymer may be provided in the form of a masterbatch that includes a carrier resin. The carrier resin may, for instance, constitute from about 0.05 wt. % to about 15 wt. %, in some embodiments from about 0.1 wt. % to about 10 wt. %, and in some embodiments, from about 0.5 wt. % to about 8 wt. % of the polymer composition. Any of a variety of carrier resins may be employed, such as polyolefins (ethylene polymer, propylene polymers, etc.), polyamides, etc. In one embodiment, for example, the carrier resin is an ethylene polymer. The ethylene polymer may be a copolymer of ethylene and an α-olefin, such as a C₃-C₂₀ α-olefin or C₃-C₁₂ α-olefin. Suitable α-olefins may be linear or branched (e.g., one or more C₁-C₃ alkyl branches, or an aryl group). Specific examples include 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin comonomers are 1-butene, 1-hexene and 1-octene. The ethylene content of such copolymers may be from about 60 mole % to about 99 mole %, in some embodiments from about 80 mole % to about 98.5 mole %, and in some embodiments, from about 87 mole % to about 97.5 mole %. The α-olefin content may likewise range from about 1 mole % to about 40 mole %, in some embodiments from about 1.5 mole % to about 15 mole %, and in some embodiments, from about 2.5 mole % to about 13 mole %. The density of the ethylene polymer may vary depending on the type of polymer employed, but generally ranges from about 0.85 to about 0.96 grams per cubic centimeter (g/cm³). Polyethylene “plastomers”, for instance, may have a density in the range of from about 0.85 to about 0.91 g/cm³. Likewise, “linear low density polyethylene” (LLDPE) may have a density in the range of from about 0.91 to about 0.940 g/cm³; “low density polyethylene” (LDPE) may have a density in the range of from about 0.910 to about 0.940 g/cm³; and “high density polyethylene” (HDPE) may have density in the range of from about 0.940 to about 0.960 g/cm³, such as determined in accordance with ASTM D792. Some non-limiting examples of high molecular weight siloxane polymer masterbatches that may be employed include, for instance, those available from Dow Corning under the trade designations MB50-001, MB50-002, MB50-313, MB50-314 and MB50-321.

The polymer composition may also contain a heat stabilizer. By way of example, the heat stabilizer can be a phosphite stabilizer, such as an organic phosphite. For example, suitable phosphite stabilizers include monophosphites and diphosphites, wherein the diphosphite has a molecular configuration that inhibits the absorption of moisture and/or has a relatively high Spiro isomer content. For instance, a diphosphite stabilizer may be selected that has a spiro isomer content of greater than 90%, such as greater than 95%, such as greater than 98%. Specific examples of such diphosphite stabilizers include, for instance, bis(2,4-dicumylphenyl)pentaerythritol diphosphite, bis(2,4-di-t-butylphenyl)pentaerythritol diphosphite, distearyl pentaerythritol diphosphite, mixtures thereof, etc. When employed, heat stabilizers typically constitute from about 0.1 wt. % to about 3 wt. %, and in some embodiments, from about 0.2 wt. % to about 2 wt. % of the composition.

A nucleating agent may also be employed to further enhance the crystallization properties of the composition. One example of such a nucleating agent is an inorganic crystalline compound, such as boron-containing compounds (e.g., boron nitride, sodium tetraborate, potassium tetraborate, calcium tetraborate, etc.), alkaline earth metal carbonates (e.g., calcium magnesium carbonate), oxides (e.g., titanium oxide, aluminum oxide, magnesium oxide, zinc oxide, antimony trioxide, etc.), silicates (e.g., talc, sodium-aluminum silicate, calcium silicate, magnesium silicate, etc.), salts of alkaline earth metals (e.g., calcium carbonate, calcium sulfate, etc.), and so forth. Boron nitride (BN) has been found to be particularly beneficial when employed in the polymer composition of the present invention. Boron nitride exists in a variety of different crystalline forms (e.g., h-BN—hexagonal, c-BN—cubic or spharlerite, and w-BN—wurtzite), any of which can generally be employed in the present invention. The hexagonal crystalline form is particularly suitable due to its stability and softness.

If desired, a crosslinking system may also be employed in combination with any optional impact modifier(s) to help further improve the strength and flexibility of the composition under a variety of different conditions. In such circumstances, a crosslinked product may be formed from a crosslinkable polymer composition that contains the polyarylene sulfide(s), in conjunction with one or more of impact modifier(s), siloxane polymer(s), filler(s) and crosslinking system as well as any other additives. When employed, such a crosslinking system, which may contain one or more crosslinking agents, typically constitutes from about 0.1 to about 15 parts, in some embodiments from about 0.2 to about 10 parts, and in some embodiments, from about 0.5 to about 5 parts per 100 parts of the polyarylene sulfide(s), as well as from about 0.05 wt. % to about 15 wt. %, in some embodiments from about 0.1 wt. % to about 10 wt. %, and in some embodiments, from about 0.2 wt. % to about 5 wt. % of the polymer composition. Through the use of such a crosslinking system, the compatibility and distribution of the polyarylene sulfide and impact modifier can be significantly improved. For example, the impact modifier is capable of being dispersed within the polymer composition in the form of discrete domains of a nano-scale size. For example, the domains may have an average cross-sectional dimension of from about 1 to about 1000 nanometers, in some embodiments from about 5 to about 800 nanometers, in some embodiments from about 10 to about 500 nanometers. The domains may have a variety of different shapes, such as elliptical, spherical, cylindrical, plate-like, tubular, etc. Such improved dispersion can result in either better mechanical properties or allow for equivalent mechanical properties to be achieved at lower amounts of impact modifier.

Any of a variety of different crosslinking agents may generally be employed within the crosslinking system. In one embodiment, for instance, the crosslinking system may include a metal carboxylate. Without intending to be limited by theory, it is believed that the metal atom in the carboxylate can act as a Lewis acid that accepts electrons from the oxygen atom located in a functional group (e.g., epoxy functional group) of the impact modifier. Once it reacts with the carboxylate, the functional group can become activated and can be readily attacked at either carbon atom in the three-membered ring via nucleophilic substitution, thereby resulting in crosslinking between the chains of the impact modifier. The metal carboxylate is typically a metal salt of a fatty acid. The metal cation employed in the salt may vary, but is typically a divalent metal, such as calcium, magnesium, lead, barium, strontium, zinc, iron, cadmium, nickel, copper, tin, etc., as well as mixtures thereof. Zinc is particularly suitable. The fatty acid may generally be any saturated or unsaturated acid having a carbon chain length of from about 8 to 22 carbon atoms, and in some embodiments, from about 10 to about 18 carbon atoms. If desired, the acid may be substituted. Suitable fatty acids may include, for instance, lauric acid, myristic acid, behenic acid, oleic acid, palmitic acid, stearic acid, ricinoleic acid, capric acid, neodecanoic acid, hydrogenated tallow fatty acid, hydroxy stearic acid, the fatty acids of hydrogenated castor oil, erucic acid, coconut oil fatty acid, etc., as well as mixtures thereof. Metal carboxylates typically constitute from about 0.05 wt. % to about 5 wt. %, in some embodiments from about 0.1 wt. % to about 2 wt. %, and in some embodiments, from about 0.2 wt. % to about 1 wt. % of the polymer composition.

The crosslinking system may also employ a crosslinking agent that is “multi-functional” to the extent that it contains at least two reactive, functional groups. Such a multi-functional crosslinking reagent may serve as a weak nucleophile, which can react with activated functional groups on the impact modifier (e.g., epoxy functional groups). The multi-functional nature of such molecules enables them to bridge two functional groups on the impact modifier, effectively serving as a curing agent. The multi-functional crosslinking agents generally include two or more reactively functional terminal moieties linked by a bond or a non-polymeric (non-repeating) linking component. By way of example, the crosslinking agent can include a di-epoxide, poly-functional epoxide, diisocyanate, polyisocyanate, polyhydric alcohol, water-soluble carbodiimide, diamine, diol, diaminoalkane, multi-functional carboxylic acid, diacid halide, etc. Multi-functional carboxylic acids and amines are particularly suitable. Specific examples of multi-functional carboxylic acid crosslinking agents can include, without limitation, isophthalic acid, terephthalic acid, phthalic acid, 1,2-di(p-carboxyphenyl)ethane, 4,4′-dicarboxydiphenyl ether, 4,4′-bisbenzoic acid, 1,4- or 1,5-naphthalene dicarboxylic acids, decahydronaphthalene dicarboxylic acids, norbornene dicarboxylic acids, bicyclooctane dicarboxylic acids, 1,4-cyclohexanedicarboxylic acid (both cis and trans), 1,4-hexylenedicarboxylic acid, adipic acid, azelaic acid, dicarboxyl dodecanoic acid, succinic acid, maleic acid, glutaric acid, suberic acid, azelaic acid and sebacic acid. The corresponding dicarboxylic acid derivatives, such as carboxylic acid diesters having from 1 to 4 carbon atoms in the alcohol radical, carboxylic acid anhydrides or carboxylic acid halides may also be utilized. In certain embodiments, aromatic dicarboxylic acids are particularly suitable, such as isophthalic acid or terephthalic acid.

When employed, multi-functional crosslinking agents typically constitute from about 50 wt. % to about 95 wt. %, in some embodiments from about 60 wt. % to about 90 wt. %, and in some embodiments, from about 70 wt. % to about 85 wt. % of the crosslinking system, while the metal carboxylates typically constitute from about 5 wt. % to about 50 wt. %, in some embodiments from about 10 wt. % to about 40 wt. %, and in some embodiments, from about 15 wt. % to about 30 wt. % of the crosslinking system. For example, the multi-functional crosslinking agents may constitute from about 0.1 wt. % to about 10 wt. %, in some embodiments from about 0.2 wt. % to about 5 wt. %, and in some embodiments, from about 0.5 wt. % to about 3 wt. % of the polymer composition. Of course, in certain embodiments, the composition may be generally free of multi-functional crosslinking agents, or the crosslinking system may be generally free of metal carboxylates.

Still other components that can be included in the composition may include, for instance, nucleating agents, particulate fillers (e.g., talc, mica, etc.), pigments (e.g., black pigments), colorants, antioxidants, stabilizers, surfactants, lubricants, and other materials added to enhance properties and processability.

The manner in which the polyarylene sulfide and optional additives are combined may vary as is known in the art. For instance, the materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the components may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 100° C. to about 500° C., and in some embodiments, from about 150° C. to about 300° C. Likewise, the apparent shear rate during melt processing may range from about 100 seconds⁻¹ to about 10,000 seconds⁻¹, and in some embodiments, from about 500 seconds⁻¹ to about 1,500 seconds⁻¹. Of course, other variables, such as the residence time during melt processing, which is inversely proportional to throughput rate, may also be controlled to achieve the desired degree of homogeneity.

If desired, one or more distributive and/or dispersive mixing elements may be employed within the mixing section of the melt processing unit. Suitable distributive mixers may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further increased in aggressiveness by using pins in the barrel that create a folding and reorientation of the polymer melt, such as those used in Buss Kneader extruders, Cavity Transfer mixers, and Vortex Intermeshing Pin mixers. The speed of the screw can also be controlled to improve the characteristics of the composition. For instance, the screw speed can be about 400 rpm or less, in one embodiment, such as between about 200 rpm and about 350 rpm, or between about 225 rpm and about 325 rpm. In one embodiment, the compounding conditions can be balanced so as to provide a polymer composition that exhibits improved properties. For example, the compounding conditions can include a screw design to provide mild, medium, or aggressive screw conditions. For example, system can have a mildly aggressive screw design in which the screw has one single melting section on the downstream half of the screw aimed towards gentle melting and distributive melt homogenization. A medium aggressive screw design can have a stronger melting section upstream from the filler feed barrel focused more on stronger dispersive elements to achieve uniform melting. Additionally, it can have another gentle mixing section downstream to mix the fillers. This section, although weaker, can still add to the shear intensity of the screw to make it stronger overall than the mildly aggressive design. A highly aggressive screw design can have the strongest shear intensity of the three. The main melting section can be composed of a long array of highly dispersive kneading blocks. The downstream mixing section can utilize a mix of distributive and intensive dispersive elements to achieve uniform dispersion of all type of fillers. The shear intensity of the highly aggressive screw design can be significantly higher than the other two designs. In one embodiment, a system can include a medium to aggressive screw design with relatively mild screw speeds (e.g., between about 200 rpm and about 300 rpm).

The crystallization temperature of the resulting polymer composition (prior to being formed into a shaped part) may be about 250° C. or less, in some embodiments from about 100° C. to about 245° C., and in some embodiments, from about 150° C. to about 240° C. The polymer composition may also exhibit a relatively low melt viscosity, such as about 30 kP or less, in some embodiments about 20 kP or less, in some embodiments about 10 kP or less, in some embodiments about 5 kP or less, and in some embodiments, from about 2 to about 50 kP, as determined in accordance with ISO 11443:2021 at a temperature of about 310° C. and at a shear rate of 400 s⁻¹.

The resulting composition may also exhibit other properties that enables it to be readily employed in a wide variety of product applications (e.g., electric vehicle) even at relatively small part thickness values, such as about 4 millimeters or less, in some embodiments about from about 0.2 to about 3.2 millimeters, in some embodiments from about 0.4 to about 2.5 millimeters, and in some embodiments, from about 0.8 to about 2 millimeters.

The polymer composition may, for example, exhibit a tensile stress at break (i.e., strength) of from about 100 MPa to about 300 MPa, in some embodiments from about 120 MPa to about 250 MPa, in some embodiments from about 130 to about 220 MPa, and in some embodiments, from about 140 to about 200 MPa; a tensile break strain (i.e., elongation) of about 1% or more, in some embodiments from about 1.2% to about 8%, and in some embodiments, from about 1.5% to about 5%; and/or a tensile modulus of about 15,000 MPa or less, in some embodiments from about 1,000 MPa to about 12,000 MPa, in some embodiments from about 5,000 MPa to about 11,000 MPa. The tensile properties may be determined in accordance with ISO 527:2019 at a temperature of 23° C. The composition may also exhibit a flexural strength of about 20 MPa or more, in some embodiments from about 25 to about 200 MPa, in some embodiments from about 30 to about 150 MPa, and in some embodiments, from about 35 to about 100 MPa and/or a flexural modulus of about 10,000 MPa or less, in some embodiments from about 500 MPa to about 8,000 MPa, in some embodiments from about 1,000 MPa to about 6,000 MPa, and in some embodiments, from about 1,500 MPa to about 5,000 MPa. The flexural properties may be determined in accordance with ISO 178:2019 at a temperature of 23° C. The polymer composition may also exhibit a high impact strength, which can provide enhanced flexibility for the resulting part. For example, the polymer composition may exhibit a notched Charpy impact strength of about 2 kJ/m² or more, in some embodiments from about 4 to about 40 kJ/m², and in some embodiments, from about 5 to about 20 kJ/m², as determined at a temperature of 23° C. in accordance with ISO 179-1:2010.

Notably, the polymer composition may not be highly sensitive to the presence of aqueous coolant solutions at high temperatures. For example, the polymer composition may be placed into contact with a solution containing 50 vol. % deionized water and 50 vol. % of ethylene glycol at a temperature of about 100° C. or more, in some embodiments from about 110° C. to about 200° C., and in some embodiments, from about 120° C. to about 180° C. (e.g., 135° C.). Even when exposed to an aqueous coolant solution at such high temperatures, the mechanical properties (e.g., impact strength, tensile properties, etc.) may remain close to or even within the ranges noted above. The mechanical properties can also remain stable at such temperatures for a substantial period of time, such as for about 100 hours or more, in some embodiments from about 200 hours to about 3,000 hours, and in some embodiments, from about 250 hours to about 2,000 hours (e.g., 250, 500, 1,000, 1,500, or 2,000 hours).

After “aging” at 135° C. for 1,000 hours in the solution, for example, the ratio of the aged tensile strength to the initial tensile strength prior to such aging may be about 0.8 or more, in some embodiments about 0.85 or more, and in some embodiments, from about 0.9 to 1.0; the ratio of the aged tensile elongation to the initial tensile elongation prior to such aging may be about 0.7 or more, in some embodiments about 0.75 or more, and in some embodiments, from about 0.8 to 1.0; and/or the ratio of the aged tensile modulus to the initial tensile modulus prior to such aging may be about 0.8 or more, in some embodiments about 0.85 or more, and in some embodiments, from about 0.9 to 1.2. For example, the tensile strength after aging in the solution at 135° C. for 1,000 hours may be from about 80 MPa to about 300 MPa, in some embodiments from about 125 MPa to about 250 MPa, in some embodiments from about 130 to about 220 MPa, and in some embodiments, from about 140 to about 200 MPa, as determined at a temperature of about 23° C. in accordance with ISO 527:2019. Likewise, the tensile elongation after aging in the solution at 135° C. for 1,000 hours may, for instance, be about 0.7% or more, in some embodiments from about 1% to about 8%, in some embodiments from about 1.2% to about 5%, and in some embodiments, from about 1.4% to about 4%, as determined at a temperature of about 23° C. in accordance with ISO 527:2019. After aging in the solution at 135° C. for 1,000 hours, the ratio of the aged Charpy notched impact strength to the initial impact strength prior to such aging may also be about 0.6 or more, in some embodiments about 0.7 or more, and in some embodiments, from about 0.8 to 1.0. For example, the Charpy notched impact strength after aging in the solution at 135° C. for 1,000 hours may be about 1 kJ/m² or more, in some embodiments about 2 kJ/m² or more, in some embodiments from about 4 to about 20 kJ/m², and in some embodiments, from about 5 to about 15 kJ/m², as determined at a temperature of 23° C. in accordance with ISO Test No. 179-1:2010.

The polymer composition may also exhibit good heat resistance and flame retardancy. The melting temperature of the composition may, for instance, be from about 250° C. to about 440° C., in some embodiments from about 260° C. to about 400° C., and in some embodiments, from about 280° C. to about 380° C. Even at such melting temperatures, the ratio of the deflection temperature under load (“DTUL”), a measure of short term heat resistance, to the melting temperature may still remain relatively high. For example, the ratio may range from about 0.5 to about 1.00, in some embodiments from about 0.6 to about 0.95, and in some embodiments, from about 0.65 to about 0.85. The specific DTUL values may, for instance, range be about 260° C. or more, in some embodiments from about 260° C. to about 350° C., and in some embodiments, from about 265° C. to about 320° C., such as determined in accordance with ISO 75:2013 at a load of 1.8 MPa. Such high DTUL values can, among other things, allow the use of high speed and reliable surface mounting processes for mating the structure with other components of an electrical component. The flame retardant properties of the composition may likewise be characterized in accordance the procedure of Underwriter's Laboratory Bulletin 94 entitled “Tests for Flammability of Plastic Materials, UL94.” Several ratings can be applied based on the time to extinguish ((total flame time of a set of 5 specimens) and ability to resist dripping as described in more detail below. According to this procedure, for example, the composition may exhibit a V0 rating at a part thickness such as noted above (e.g., from about 0.4 to about 3.2 millimeters, e.g., 0.4, 0.8, or 1.6 millimeters), which means that it has a total flame time of about 50 seconds or less. To achieve a V0 rating, the composition may also exhibit a total number of drips of burning particles that ignite cotton of 0.

### IV. Product Components

A variety of different components may be formed using the polymer composition described herein. Moreover, a component may be formed from the polymer composition using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer composition for a desired time period to allow for solidification. The molded product may then be solidified by bringing it to a temperature below that of the melting temperature. The resulting product may be de-molded. The cycle time for each molding process may be adjusted to suit the polymer composition, to achieve sufficient bonding, and to enhance overall process productivity.

The polymer compositions are particularly beneficial for use in components of an electric vehicle, such as a battery-powered electric vehicle, fuel cell-powered electric vehicle, plug-in hybrid-electric vehicle (PHEV), mild hybrid-electric vehicle (MHEV), full hybrid-electric vehicle (FHEV), etc. Referring to FIG. 1, for instance, one embodiment of an electric vehicle 112 that includes a powertrain 110 is shown. The powertrain 110 contains one or more electric machines 114 connected to a transmission 116, which in turn is mechanically connected to a drive shaft 120 and drive wheels 122. Although by no means required, the transmission 116 in this particular embodiment is also connected to an engine 118, though the description herein is equally applicable to a pure electric vehicle. The electric machines 114 may be capable of operating as a motor or a generator to provide propulsion and deceleration capability. The powertrain 110 also includes a propulsion source, such as a battery assembly 124, which stores and provides energy for use by the electric machines 114. The battery assembly 124 typically provides a high voltage current output (e.g., DC current at a voltage of from about 400 volts to about 800 volts) from one or more battery cell arrays that may include one or more battery cells.

The powertrain 110 may also contain at least one power electronics module 126 that is connected to the battery assembly 124 (also commonly referred to as a battery pack) and that may contain a power converter (e.g., converter, etc., as well as combinations thereof). The power electronics module 126 is typically electrically connected to the electric machines 114 and provides the ability to bi-directionally transfer electrical energy between the battery assembly 124 and the electric machines 114. For example, the battery assembly 124 may provide a DC voltage while the electric machines 114 may require a three-phase AC voltage to function. The power electronics module 126 may convert the DC voltage to a three-phase AC voltage as required by the electric machines 114. In a regenerative mode, the power electronics module 126 may convert the three-phase AC voltage from the electric machines 114 acting as generators to the DC voltage required by the battery assembly 124. The battery assembly 124 may also provide energy for other vehicle electrical systems. For example, the powertrain may employ a DC/DC converter module 128 that converts the high voltage DC output from the battery assembly 124 to a low voltage DC supply that is compatible with other vehicle loads, such as compressors and electric heaters. In a typical vehicle, the low-voltage systems are electrically connected to an auxiliary battery 130 (e.g., 12V battery). A battery energy control module (BECM) 133 may also be present that is in communication with the battery assembly 124 that acts as a controller for the battery assembly 124 and may include an electronic monitoring system that manages temperature and charge state of each of the battery cells. The battery assembly 124 may also have a temperature sensor 131, such as a thermistor or other temperature gauge. The temperature sensor 131 may be in communication with the BECM 133 to provide temperature data regarding the battery assembly 124. The temperature sensor 131 may also be located on or near the battery cells within the traction battery 124. It is also contemplated that more than one temperature sensor 131 may be used to monitor temperature of the battery cells.

In certain embodiments, the battery assembly 124 may be recharged by an external power source 136, such as an electrical outlet. The external power source 136 may be electrically connected to electric vehicle supply equipment (EVSE) that regulates and manages the transfer of electrical energy between the power source 36 and the vehicle 112. The EVSE 138 may have a charge connector 140 for plugging into a charge port 134 of the vehicle 112. The charge port 134 may be any type of port configured to transfer power from the EVSE 138 to the vehicle 112 and may be electrically connected to a charger or on-board power conversion module 132. The power conversion module 132 may condition the power supplied from the EVSE 138 to provide the proper voltage and current levels to the battery assembly 124. The power conversion module 132 may interface with the EVSE 138 to coordinate the delivery of power to the vehicle 112.

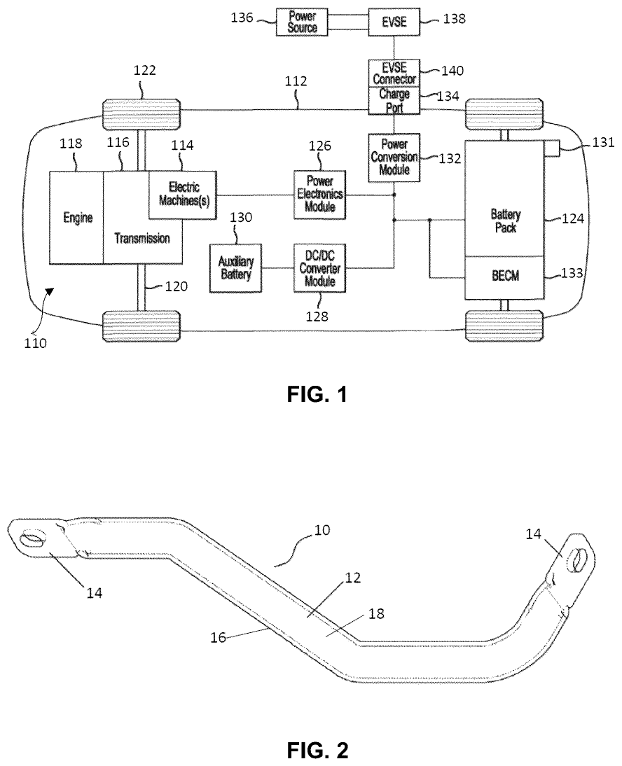

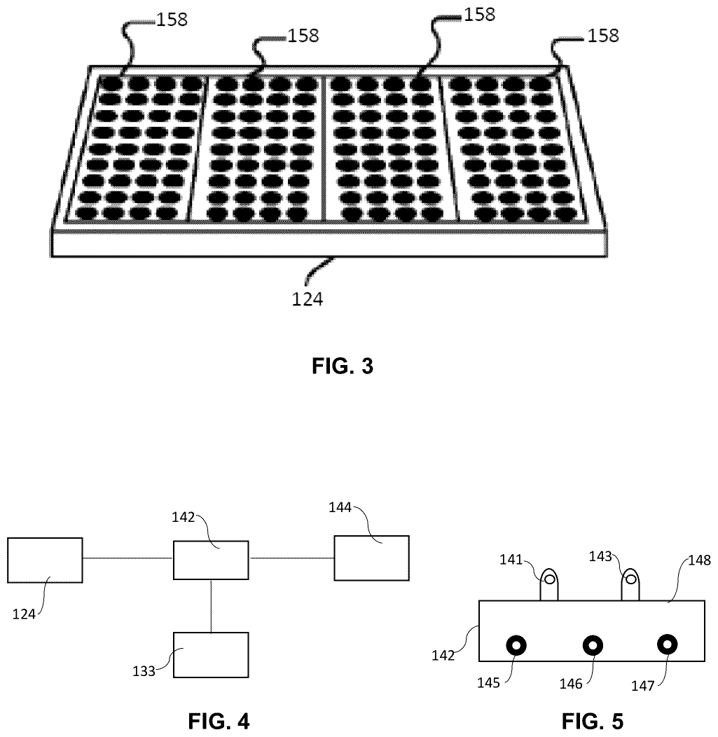

The polymer composition described herein can be included in various components of an electric vehicle as illustrated in FIG. 1. For instance, a busbar, one example of which is illustrated in FIG. 2, may be used to electrically connect individual cells of the battery assembly 124. Referring to FIG. 3, for example, the battery assembly 124 can include a number of battery cells 158. The battery cells 158 may be stacked side-by-side to construct a grouping of battery cells, sometimes referred to as a battery array. In one embodiment, the battery cells 158 are prismatic, lithium-ion cells. However, battery cells having other geometries (cylindrical, pouch, etc.) and/or chemistries (nickel-metal hydride, lead-acid, etc.) could alternatively be utilized within the scope of this disclosure. Each battery cell 158 includes a positive terminal (designated by the symbol (+)) and a negative terminal (designed by the symbol (−)). The battery cells 158 are arranged such that each battery cell 158 terminal is disposed adjacent to a terminal of an adjacent battery cell 158 having an opposite polarity. As used herein, the terms “battery”, “cell”, and “battery cell” may be used interchangeably to refer to any type of individual battery element used in a battery system. The batteries described herein typically include lithium-based batteries, but may also include various chemistries and configurations including iron phosphate, metal oxide, lithium-ion polymer, nickel metal hydride, nickel cadmium, nickel-based batteries (hydrogen, zinc, cadmium, etc.), and any other battery type compatible with an electric vehicle. For example, some embodiments may use the 6831 NCR 18650 battery cell from Panasonic©, or some variation on the 18650 form-factor of 6.5 cm×1.8 cm and approximately 45 g.

The manner in which a busbar connects to individual battery cells of a battery assembly 124, such as shown in FIG. 3, may vary as is known in the art. Referring to FIG. 2, one embodiment of a busbar 10 is shown that includes a conductive body 12. The body 12 includes a conductive material 18, such as copper, aluminum, aluminum alloy, etc., and can generally be in the form of a solid bar, hollow tube, and so forth. The busbar 10 includes a connector portion 14 at either end that is configured to mate with respective terminations of two or more batteries. An insulative portion 16 (e.g., coating or molded material) that includes the polymer composition as described herein may cover a portion of the conductive material of the body 12. To form the busbar 10, the insulative portion 16 can be applied to the surface of the conductive material 18. For instance, a bar or tube of the conductive material 18 can be inserted into a pre-formed tube of the insulating coating 16, e.g., an extruded tube sized and cut to the correct proportions, following which the busbar 10 can be shaped to any suitable form. In another embodiment, the insulating coating can be applied to the surface of the conductive material 18 in the melt, and can solidify on the surface of the conductive material in the applied areas.

Of course, a busbar may be provided in any suitable shape and size. For instance, a busbar may be used as a template for placing the individual battery cells so that they are uniform in each battery assembly manufactured. In such an embodiment, a busbar may hold individual batteries of a battery assembly 124 in place during the manufacturing process and thermal padding or injection-housings, which can be formed of a polymer composition as described herein, can be added without causing the individual battery cells to shift out of position.

Apart from busbars, other components may also employ the polymer composition of the present invention. For instance, FIG. 4 presents a block diagram of battery electronics of an electric vehicle 112. The illustrated battery electronics system includes a battery assembly 124 and a current sensor 142. As shown, current sensor 142 is connected between battery assembly 124 and load/source 144. The current sensor 142 can be configured to measure the current flowing from the battery assembly 124 to the load/source 144 when load/source 144 is a load such as one or more electric machines 114. Likewise, current sensor 142 can be configured to measure the current flowing to battery assembly 124 from load/source 144 when the load/source 144 is a source such as an external power source 136. The (BECM) 133 can be configured to power current sensor 142 to enable its operation. The BECM 133 can further be configured to read an output generated by current sensor 142 which is indicative of the current flowing between battery assembly 124 and load/source 144.

FIG. 5 illustrates one embodiment of a current sensor 142. A current sensor 142 can include a current in port 141 and a current out port 143 as well as standard ground 145, voltage at common collector (VCC) 146, and output port(s) 147. The current sensor 142 can also include a housing 148 that includes the polymer composition as described that can house other components of the current sensor 142, e.g., resistors, capacitors, converters, processing chips, etc.

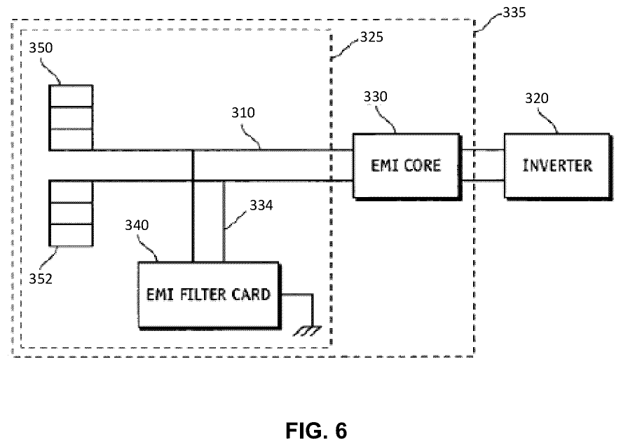

Another component of an electric vehicle as may incorporate the polymer compositions as described is an inverter system, one exemplary embodiment of which is illustrated in FIG. 6. The system includes an inverter module 320 and an interconnection system 335. The interconnection system 335 includes an Electromagnetic Interference (EMI) core 330 and an EMI filter apparatus 325. The inverter module 320 is coupled to the interconnection system 335 by a pair of bus bars 310. The EMI core 330 is located between the EMI filter apparatus 325 and the inverter module 320 and is in communication with the bus bars 310. The EMI filter apparatus 325 includes an EMI filter card 340 and a pair of bolts 350, 352 which include a positive terminal (+) bolt 350 and a negative terminal (−) bolt 352 for coupling to a power source, e.g., the battery assembly 124. The EMI core 330 is coupled to the bolts 350, 352 by the bus bars 310. The EMI filter card 340 is also coupled between ground and the bus bars 310 via a pair of wires 334. An inverter module 320 includes a number of transistors (not shown). Transistors in an inverter module 320 switch on and off relatively rapidly (e.g., 5 to 20 kHz). This switching tends to generate electrical switching noise. The electrical switching noise should ideally be contained inside the inverter module 320 and prevented from entering the rest of the electrical system to prevent interference with other electrical components in the vehicle.

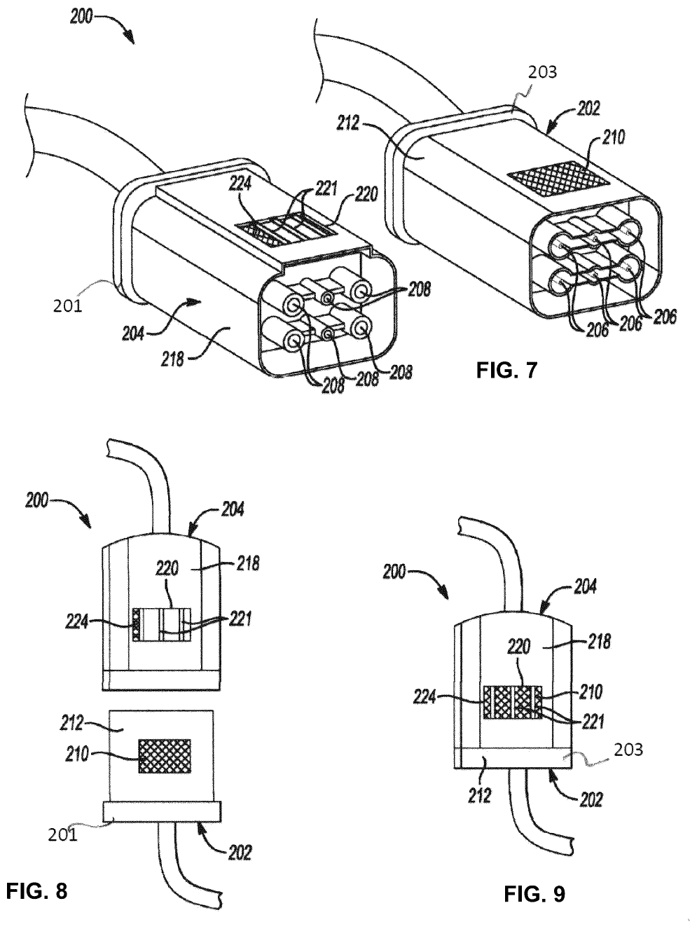

An inverter system can include several components that can incorporate a polymer composition as disclosed including, without limitation, the EMI filter apparatus 325, e.g., as a housing and/or internal support structures, an EMI filter card 340, the bus bars 310, as well as connectors employed within the system. For example, an electrical connector that includes the polymer composition as described herein may be employed in an inverter system as in FIG. 7 or within another portion of an electric vehicle. An electrical connector can in general include a first connector portion that contains at least one electrical contact and an insulating member that surrounds at least a portion of the connector portion. The insulating member may contain the polymer composition of the present invention. The first connector portion may be configured to mate with an opposing second connector portion that contains a receptacle for receiving the electrical contact. In such embodiments, the second connector portion may contain at least one receptacle configured to receive the electrical contact of the first connector portion and an insulating member that surrounds at least a portion of the second connector portion. The insulating member of the second connector portion may also contain the polymer composition of the present invention.

Referring to FIGS. 7-9, one particular embodiment of a connector 200 is shown for use in an electric vehicle, e.g., in an electric vehicle powertrain. The connector 200 contains a first connector portion 202 and a second connector portion 204. The first connector portion 202 may include one or more electrical pins 206 and the second connector portion 204 may include one or more receptacles 208 for receiving the electrical pins 206. A first insulator member 212 may extend from a base 203 of the first connecting portion 202 to surround the pins 206, and similarly, a second insulator member 218 may extend from a base 201 of the second connecting portion 204 to surround the receptacles 208. In certain cases, the periphery of the first insulator member 212 may extend beyond an end of the electrical pins 203 and the periphery of the second insulator member 218 may extend beyond an end of the receptacles 208. The base 203 and/or the first insulator member 212 of the first connector portion 202, as well as the base 201 and/or the second insulator member 218 of the second connector portion 204, may be formed from the polymer composition of the present invention.

Although by no means required, the first connector portion 202 may also include an identification mark 210 secured to or defined by the first protective member 212. The second connecting portion 204 may also optionally define an alignment window 220 sized according to the identification mark 210 to more easily determine when the portions are fully mated. For instance, the identification mark 210 may not be readable unless blockers 221 cover a portion of the identification mark 210. Optionally, the second connecting portion 204 may include a supplemental mark 224 located adjacent to the alignment window 220.

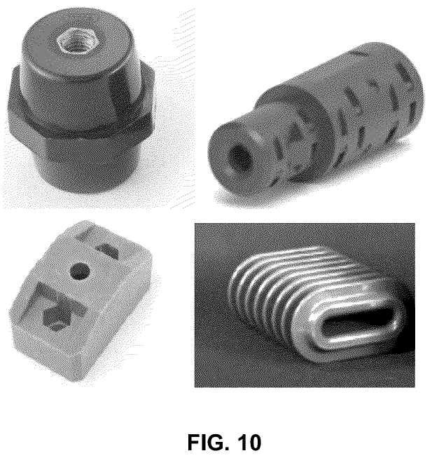

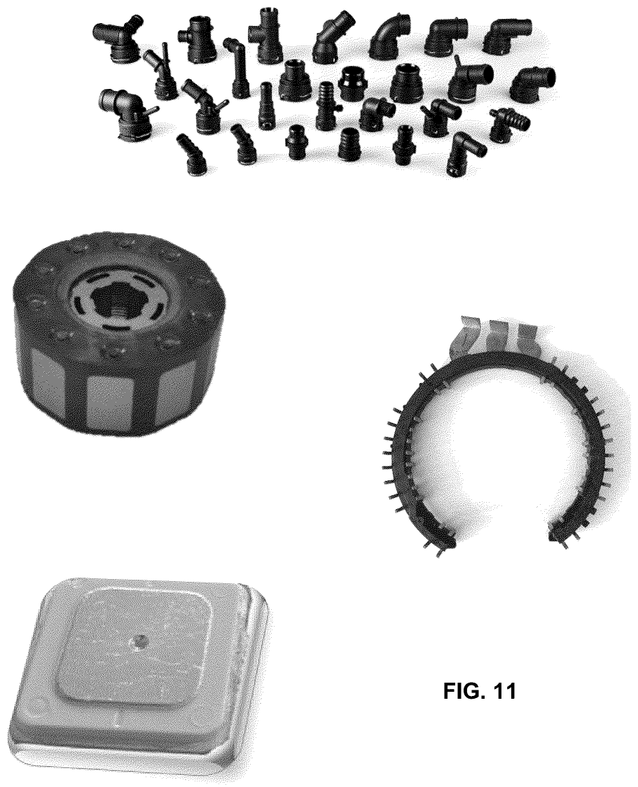

FIGS. 10-11 illustrate yet other examples of components that may employ the polymer composition of the present invention, such as spacers, connectors, insulators and supports as shown in FIG. 10 and that can be formed from the polymer composition. Components as may incorporate a polymer composition illustrated in FIG. 11 include quick connects, tees, and interconnectors, a plurality of which are illustrated at the top of FIG. 11; brushless direct current motors (middle left of FIG. 11), e.g., sealing rings, housings, supports, etc. of a motor; guide rails (middle right of FIG. 11, also illustrating additional examples of busbars in the image); and battery sealing rings (bottom of FIG. 11).

Systems that can employ the polymer composition of the present invention are in no way limited to only electrical systems. For example, a thermal management system can also beneficially incorporate the polymer composition. A thermal management system of an electric vehicle can generally include multiple different subsystems such as, without limitation, a power train subsystem, a refrigeration subsystem, a battery cooling subsystem, and a heating, ventilation, and cooling (HVAC) subsystem. In some embodiments, one or more subsystems of a thermal management system may in fluid communication with one another, thus allowing hot heat transfer medium to flow from the high temperature circuit into the low temperature circuit, and cooler heat transfer medium to flow from the low temperature circuit into the high temperature circuit.

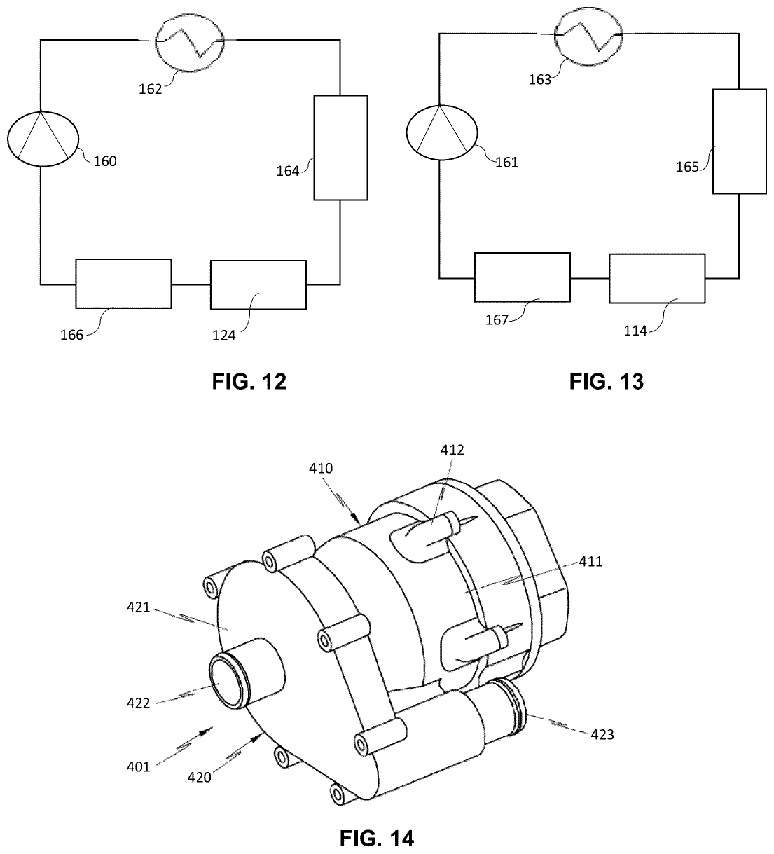

By way of example, FIG. 12 illustrates a first temperature control loop and FIG. 13 illustrates a second temperature control loop as may be found in electric vehicles, each of which designed for different subsystems and each of which including one or more components that can employ a polymer compositions of the invention. By way of example, a first temperature control loop in a typical electric vehicle (FIG. 12) can include a heat transfer medium (e.g., water, coolant, or a mixtures thereof) that is pumped through the loop via a suitable pump 160, e.g., an electric pump, and cooled via heat transfer with a refrigerant in a heat exchanger 162 (e.g., an energy storage system (ESS) heat exchanger) as well as a radiator/reservoir 164. Additionally, the loop can include a heater 166 e.g., a positive temperature coefficient (PTC) heater, which can ensure that the temperature of the system can be maintained within its preferred operating range regardless of the ambient temperature, and the battery assembly 124. A second temperature control loop (FIG. 13) can also include a heat transfer medium that can be the same or differ from the heat transfer medium of another subsystem. The heat transfer medium of the second temperature control loop can be pumped through the loop with a suitable pump 161, a heat exchanger 162, and a radiator reservoir 165. A high temperature control loop can be utilized in cooling the power electronics 167 as well as the electric machines 114 of the vehicle.

One example of a component of a heat management system as may incorporate the polymer composition of the invention is a coolant pump, e.g., an electric pump, an example of which is illustrated in FIG. 14. As shown, the electric pump 401 includes an electric motor 410 as a drive source and a hydraulic portion 420 for generating coolant suction and discharge forces. The motor 410 and associated components are retained with in the motor housing 411. The hydraulic portion 420 includes a volute casing 421 that generally includes a spiral flow space, an inlet 422, and outlet 423, and an impeller (not shown) rotated by the electric motor 410. The pump 401 has an interface including a mechanical seal (not shown), for sealing and separating the water flow space and the motor chamber. Generally, a mounting portion 412 is provided on the motor housing 411 to mount the pump 401 in the vehicle. Components of the electric pump 401 such as housings, casings, interfaces, etc. can incorporate the polymer composition of the invention.

The following test methods may be used to help determine the properties referenced herein.

### Test Methods

Melt Viscosity: The melt viscosity (Pa-s) may be determined in accordance with ISO 11443:2021 at a shear rate of 400 s⁻¹ and using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod was 233.4 mm. The melt viscosity is typically determined at a temperature of 310° C.

Chlorine Content: Chlorine content may be determined according to known techniques, such as by elemental analysis using Parr Bomb combustion followed by Ion Chromatography or by oxidation of PPS to PPSO followed by NMR measurement of bound chlorine.

Tensile Modulus, Tensile Stress at Break, and Tensile strain at Break: Tensile properties may be tested according to ISO 527-2/1A:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 5 mm/min for tensile strength and tensile strain at break, and 1 mm/min for tensile modulus.

Flexural Modulus and Flexural Stress: Flexural properties may be tested according to ISO 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO 179-1:2010) (technically equivalent to ASTM D256-10, Method B). This test may be run using a Type 1 specimen size (length of 80 mm, width of 10 mm, and thickness of 4 mm). Specimens may be cut from the center of a multi-purpose bar using a single tooth milling machine. The testing temperature may be 23° C. For “notched” impact strength, this test may be run using a Type A notch (0.25 mm base radius) and Type 1 specimen size (length of 80 mm, width of 10 mm, and thickness of 4 mm).

Hydrolytic Testing: An autoclave with a 4-liter capacity may be used to conduct high temperature hydrolysis testing. The autoclave contains an immersion heater and a temperature control system. The autoclave is initially filled with a solution containing 50 vol. % deionized water and 50 vol. % ethylene glycol. Samples having a volume of 7.5 liters are then fully immersed into the solution. The autoclave is closed and the solution is heated to 135° C., which results in an internal pressure of about 2-3 bars. After testing for 1,000 hours, the autoclave is cooled to room temperature (about 23° C.), the pressure is released, and the set of tensile bars is withdrawn for further testing.

UL94: A specimen is supported in a vertical position and a flame is applied to the bottom of the specimen. The flame is applied for ten (10) seconds and then removed until flaming stops, at which time the flame is reapplied for another ten (10) seconds and then removed. Two (2) sets of five (5) specimens are tested. The sample size is a length of 125 mm, width of 13 mm, and thickness of 0.8 mm. The two sets are conditioned before and after aging. For unaged testing, each thickness is tested after conditioning for 48 hours at 23° C. and 50% relative humidity. For aged testing, five (5) samples of each thickness are tested after conditioning for 7 days at 70° C.

| Vertical | |
|---|---|
| Ratings | Requirements |
| V-0 | Specimens must not burn with flaming combustion for more than 10 seconds after |
| | either test flame application. |
| | Total flaming combustion time must not exceed 50 seconds for each set of 5 |
| | specimens. |
| | Specimens must not burn with flaming or glowing combustion up to the specimen |
| | holding clamp. |
| | Specimens must not drip flaming particles that ignite the cotton. |
| | No specimen can have glowing combustion remain for longer than 30 seconds |
| | after removal of the test flame. |
| V-1 | Specimens must not burn with flaming combustion for more than 30 seconds after |
| | either test flame application. |
| | Total flaming combustion time must not exceed 250 seconds for each set of 5 |
| | specimens. |
| | Specimens must not burn with flaming or glowing combustion up to the specimen |
| | holding clamp. |
| | Specimens must not drip flaming particles that ignite the cotton. |
| | No specimen can have glowing combustion remain for longer than 60 seconds |
| | after removal of the test flame. |
| V-2 | Specimens must not burn with flaming combustion for more than 30 seconds after |
| | either test flame application. |
| | Total flaming combustion time must not exceed 250 seconds for each set of 5 |
| | specimens. |
| | Specimens must not burn with flaming or glowing combustion up to the specimen |
| | holding clamp. |
| | Specimens can drip flaming particles that ignite the cotton. |
| | No specimen can have glowing combustion remain for longer than 60 seconds |
| | after removal of the test flame. |

The present invention may also be better understood with reference to the following examples.

### Comparative Examples 1-4

Four (4) types of commercially available polyarylene sulfide resins (identified as PPS-1, PPS-2, PPS-3, and PPS-4) were tested for the Reactivity Value by contacting the polymer with an aqueous solution containing 0.5 wt. % 3-(aminopropyl)triethoxysilane (“APTES”). The initial melt viscosity before APTES addition (“MV1a”) was directly determined using samples of PPS as received. To determine the melt viscosity after 0.5 wt. % APTES addition (“MV2”), a dried sample of the same PPS polymer was combined with an equivalent of 0.5 wt. % of (3-aminopropyl)triethoxysilane (APTES), and the mixture was then mixed and immediately used to measure the melt viscosity at 310° C. and recorded as MV2. The results are set forth in Table 1 below.

TABLE 1

| Comp. | | Cl Content | | | Reactivity Value |
|---|---|---|---|---|---|
| Ex. | PPS | (ppm) | MV1a | MV2 | (MV2/MV1a) |
| 1 | PPS-1 | 5000 | 199 | 363 | 1.82 |
| 2 | PPS-2 | 4000 | 288 | 506 | 1.76 |
| 3 | PPS-3 | 2000 | 450 | 719 | 1.60 |
| 4 | PPS-4 | 1000 | 1408 | 2649 | 1.88 |

As indicated, the Reactivity Values measured for the different commercially available grades of PPS were below a value of 2.

### Examples 1-4

Four (4) types of commercially available polyarylene sulfide resins (identified as PPS-1, PPS-2, PPS-3, and PPS-4) were reacted with an end group-modifying compound in accordance with the present invention. More particularly, a 2 L Parr reactor was initially charged with 180 g of PPS (any of PPS-1 to -4), 20 g of 10 wt. % NaOH, and 625 g of NMP. After purging the reactor with nitrogen, it was heated up to 260° C. and held for 1.75 hours. After the hold time, about 72 ml of water was added via pump and heated back up to 260° C. The mixture was cooled to room temperature under constant stirring. The resulting slurry was filtered and the solids washed three times with acetone and then five times with water. After filtration, the product was soaked in 3% acetic acid for 1 hour then rinsed with water. The product was dried at 105° C. oven with a continues nitrogen purged. For each modified PPS, the initial melt viscosity before APTES addition (“MV1b”) was directly determined. To determine the melt viscosity after 0.5 wt. % APTES addition (“MV2”), the PPS polymer was combined with an equivalent of 0.5 wt. % of (3-aminopropyl)triethoxysilane (APTES), and the mixture was then mixed and immediately used to measure the melt viscosity at 310° C. and recorded as MV2. The results are shown in Table 2 below.

TABLE 2

| | | CI | MV1a (before | MV1b (before | MV2 | Reactivity |
|---|---|---|---|---|---|---|
| | | Content | APTES without | APTES, with | (after 0.5% | Value |
| Ex. | PPS | (ppm) | in situ SMAB) | in situ SMAB) | APTES) | (MV2/MV1a) |
| 1 | PPS-1 | 5000 | 199 | 694 | 1729 | 2.49 |
| 2 | PPS-2 | 4000 | 288 | 778 | 1871 | 2.40 |
| 3 | PPS-3 | 2000 | 450 | 633 | 1283 | 2.03 |
| 4 | PPS-4 | 1000 | 1408 | 617 | 1187 | 1.92 |

For Examples 1-3, after post-polymerization treatment of PPS with in situ-generated SMAB (from reaction of NMP and NaOH), the initial melt viscosity of the modified PPS (MV1b) increased as compared to the initial melt viscosity of the original PPS material (MV1a). For Example 4, however, when the starting MV1a was as high as about 1400 poise (MV1a), the initial melt viscosity after post-polymerization treatment (MV1b) decreased and resulted in minimal improvement in the Reactivity Value.

### Examples 5

The process of Example 1 (PPS-1) was repeated both with 10 wt. % NaOH (“Example 5”) and without NaOH in the reaction (“Control”) to determine the impact of NaOH on the resulting Reactivity Value. The results are shown in Table 3 below.

TABLE 3

| | | MV1b | MV2 | Reactivity |
|---|---|---|---|---|
| | | (before APTES, | (after | Value |
| | 10 wt. | with in | 0.5% | (MV2/ |
| Example | % NaOH | situ SMAB) | APTES) | MV1b) |
| Control | — | 180 | 292 | 1.62 |
| 5 | 20 g | 754 | 1803 | 2.39 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A method for forming a polyarylene sulfide resin, wherein the method comprises reacting an arylene sulfide polymer containing halogen end groups with an end group-modifying compound to form the polyarylene sulfide resin, wherein the end group-modifying compound includes an organic salt of an aminoalkyl carboxylic acid.

2. The method of claim 1, wherein the aminoalkyl carboxylic acid includes 4-(methylamino)butyric acid.

3. The method of claim 1, wherein the organic salt includes an alkali metal salt.

4. The method of claim 1, wherein the end-group modifying compound includes sodium N-methyl-4-aminobutyrate.

5. The method of claim 1, wherein the reacting occurs at a temperature of from about 200° C. to about 300° C.

6. The method of claim 1, wherein the end-group modifying compound is formed by a process that includes heating a reaction mixture containing an alkali metal hydroxide, water, and an N-alkylated cyclic amide to a temperature of from about 200° C. to about 300° C.

7. The method of claim 6, wherein the N-alkylated cyclic amide includes N-methylpyrrolidone.

8. The method of claim 6, wherein the alkali metal hydroxide includes sodium hydroxide.

9. The method of claim 6, wherein the reaction mixture is heated in the presence of the arylene sulfide polymer.

10. The method of claim 1, wherein the end-group modifying compound is formed by a process that includes adding an alkali metal hydroxide to a reaction mixture containing water and an N-alkylated cyclic amide, and thereafter heating the reaction to a temperature of from about 200° C. to about 300° C.

11. The method of claim 10, wherein the N-alkylated cyclic amide includes N-methylpyrrolidone.

12. The method of claim 10, wherein the alkali metal hydroxide includes sodium hydroxide.

13. The method of claim 10, wherein the reaction mixture is heated in the presence of the arylene sulfide polymer.

14. The method of claim 1, wherein the polyarylene sulfide resin has a melt viscosity of from about 100 to about 1,000 poise, as determined in accordance with ISO 11443:2021 at a shear rate of 1,200 s⁻¹ and at a temperature of 310° C.

15. The method of claim 14, wherein after treatment with an aqueous solution containing 0.5 wt. % of aminopropyltetraethoxysilane, the polyarylene sulfide resin has a melt viscosity of from about 500 to about 2,000 poise, as determined in accordance with ISO 11443:2021 at a shear rate of 1,200 s⁻¹ and at a temperature of 310° C.

16. The method of claim 1, wherein the polyarylene sulfide resin exhibits a Reactivity Value of from about 2 to about 4.

17. The method of claim 1, wherein the arylene sulfide polymer has a halogen content of about 6,000 parts per million or less.

18. The method of claim 1, wherein the halogen end groups include chlorine.

19. The method of claim 1, wherein the arylene sulfide polymer is formed by a method that comprises reacting a sulfur source with a dihaloaromatic compound during a first polymerization step to form an arylene sulfide prepolymer and reacting the arylene sulfide prepolymer with a dihaloaromatic compound during a second polymerization step to form the arylene sulfide polymer.

20. The method of claim 19, wherein the sulfur source includes a sodium sulfide, sodium hydrosulfide, a complex of sodium hydrosulfide and sodium N-methyl-4-aminobutyrate, or a combination thereof.

21. The method of claim 19, wherein the dihaloaromatic compound of the first polymerization step, the second polymerization step, or both includes p-dichlorobenzene.

22. The method of claim 19, wherein the reaction in the first polymerization step and the second polymerization step occurs in the presence of an organic amide solvent.

23. The method of claim 22, further comprising contacting the arylene sulfide prepolymer with a phase separation agent.

24. The method of claim 23, wherein the phase separation agent includes water and/or organic carboxylic acids or metal salts thereof.

25. The method of claim 1, wherein the polyarylene sulfide resin includes polyphenylene sulfide.

26. A polyarylene sulfide resin formed by the method of any of claim 1.

27. A polymer composition comprising a polymer matrix that includes the polyarylene sulfide resin of claim 26 and at least one filler.

28. The polymer composition of claim 25, wherein the filler includes glass fibers.

29. The polymer composition of claim 28, wherein the glass fibers contain a sizing composition, wherein the sizing composition contains an organosilane compound.

30. The polymer composition of claim 28, wherein the composition further contains an organosilane compound.

31. The polymer composition of claim 27, wherein the filler includes an impact modifier.

32. The polymer composition of claim 27, wherein the polymer matrix constitutes from about 40 wt. % to about 90 wt. % of the polymer composition.
